(19) United States
(12) Patent Application Publication
(10) Pub. No.: US 2017/0301299 A1
(43) Pub. Date: Oct. 19, 2017

(54) DISPLAY DEVICE, INPUT/OUTPUT DEVICE, AND DATA PROCESSOR

(71) Applicant: Semiconductor Energy Laboratory Co., Ltd., Atsugi-shi (JP)

(72) Inventors: Daisuke KUBOTA, Atsugi (JP); Yuichi YANAGISAWA, Tochigi (JP)

(21) Appl. No.: 15/483,048

(22) Filed: Apr. 10, 2017

(30) Foreign Application Priority Data
Apr. 15, 2016 (JP) 2016-082104

(51) Int. Cl. G09G 3/36; G09G 3/00

(52) U.S. Cl. CPC G09G 3/3607; G09G 3/006; G09G 2320/0673

(57) ABSTRACT

A display device includes a display panel and a correction circuit. A pixel of the display panel includes a first display element supplied with a first gray level signal and a second display element supplied with a second gray level signal. The correction circuit has a function of determining a first gray level on the basis of a first characteristic curve, and a function of generating and supplying the first gray level signal so that the first gray level is displayed by the first display element. The correction circuit has a function of determining a second gray level on the basis of a second characteristic curve, and a function of generating and supplying the second gray level signal so that the second gray level is displayed by the second display element.

### BACKGROUND OF THE INVENTION

### 1. Field of the Invention

One embodiment of the present invention relates to a display device, an input/output device, or a data processor.

Note that one embodiment of the present invention is not limited to the above technical field. The technical field of one embodiment of the invention disclosed in this specification and the like relates to an object, a method, or a manufacturing method. In addition, one embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, a memory device, a method for driving any of them, and a method for manufacturing any of them.

### 2. Description of the Related Art

A liquid crystal display device in which a light-condensing means and a pixel electrode are provided on the same surface side of a substrate and a region transmitting visible light in the pixel electrode is provided to overlap with an optical axis of the light-condensing means, and a liquid crystal display device which includes an anisotropic light-condensing means having a condensing direction X and a non-condensing direction Y that is along a longitudinal direction of a region transmitting visible light in the pixel electrode are known (Patent Document 1).

### REFERENCE

### Patent Document

### [Patent Document 1] Japanese Published Patent Application No. 2011-191750

### SUMMARY OF THE INVENTION

An object of one embodiment of the present invention is to provide a novel display device that is highly convenient or reliable. Another object is to provide a novel input/output device that is highly convenient or reliable. Another object is to provide a novel data processor that is highly convenient or reliable. Another object is to provide a novel display device, a novel input/output device, a novel data processor, or a novel semiconductor device.

Note that the descriptions of these objects do not disturb the existence of other objects. In one embodiment of the present invention, there is no need to achieve all the objects. Other objects will be apparent from and can be derived from the description of the specification, the drawings, the claims, and the like.

(1) One embodiment of the present invention is a display device including a display panel and a correction circuit.

The display panel includes a pixel including a first display element and a second display element. The second display element is provided so that display using the second display element can be seen from part of a region where display using the first display element can be seen.

The first display element has a function of receiving a first gray level signal. The second display element has a function of receiving a second gray level signal.

The correction circuit has a function of receiving gray level data, and a function of determining a first gray level on the basis of the gray level data and a first characteristic curve. The correction circuit has a function of generating the first gray level signal so that the first gray level is displayed by the first display element. The correction circuit has a function of supplying the first gray level signal.

The correction circuit has a function of determining a second gray level on the basis of the gray level data and a second characteristic curve. The correction circuit has a function of generating the second gray level signal so that the second gray level is displayed by the second display element. The correction circuit has a function of supplying the second gray level signal.

The first characteristic curve has a gamma value greater than 2.2 in the normalized state, and the second characteristic curve has a gamma value smaller than that of the first characteristic curve in the normalized state.

Thus, an image displayed using the first display element and the second display element can have a higher contrast than an image displayed using only the second display element. Furthermore, the display using the second display element can be seen from part of the region where the display using the first display element can be seen. Furthermore, users can see display without changing the attitude or the like of the display panel. Consequently, a novel display device that is highly convenient or reliable can be provided.

(2) One embodiment of the present invention is the above-described display device, in which the second display element has a function of performing display with higher color purity than the first display element.

The first characteristic curve outputs a value smaller than or equal to 0.01 in response to the input of a value smaller than or equal to 0.2 in the normalized state.

Thus, in a region with low gray level data, an image can be displayed more clearly using the second display element than using the first display element. Furthermore, an image with a wider color gamut can be displayed using the second display element than using the first display element. Consequently, a novel display device that is highly convenient or reliable can be provided.

(3) One embodiment of the present invention is the above-described display device, in which the first display element has a function of controlling reflectance, and the second display element has a function of controlling emission intensity.

(4) One embodiment of the present invention is the above-described display device, in which the first display element includes a first electrode, a second electrode, and a layer containing a liquid crystal material.

The second electrode is provided so that an electric field that controls the alignment of the liquid crystal material contained in the layer is generated between the second electrode and the first electrode.

The first display element has a function of operating in a normally white mode. The first display element has a voltage that can increase normalized reflectance from lower than 90% to higher than or equal to 90% when a voltage applied between the first electrode and the second electrode is greater than or equal to 0 V and less than or equal to 1.5 V. Furthermore, the first display element has a voltage that can increase the normalized reflectance from lower than 10% to higher than or equal to 10% when a voltage applied between the first electrode and the second electrode is greater than or equal to 0 V and less than or equal to 3.5 V, preferably greater than or equal to 0 V and less than or equal to 2.5 V.

Thus, an image displayed using the second display element and the first display element which utilizes external light incident thereon can have a higher contrast than an image displayed using only the second display element. Furthermore, a reflective display element is used as the first display element, whereby the power consumption can be reduced. Furthermore, an image with high contrast can be favorably displayed in an environment with bright external light. Furthermore, the second display element which emits light is used, whereby an image can be favorably displayed in a dark environment. Furthermore, high gray levels can be displayed while power consumption is suppressed. Consequently, a novel display device that is highly convenient or reliable can be provided.

(5) One embodiment of the present invention is the above-described display device, in which the pixel includes a first conductive film, a second conductive film, an insulating film, and a pixel circuit.

The first conductive film is electrically connected to the first electrode and the second conductive film includes a region overlapping with the first conductive film.

The insulating film includes a region positioned between the first conductive film and the second conductive film. The insulating film includes an opening.

The second conductive film is electrically connected to the first conductive film through the opening.

The pixel circuit is electrically connected to the second conductive film.

The second display element is electrically connected to the pixel circuit and has a function of emitting light toward the insulating film.

Thus, the first display element and the second display element that displays an image using a method different from that of the first display element can be driven using pixel circuits that can be formed in the same process. Specifically, a reflective display element is used as the first display element, whereby the power consumption can be reduced. Furthermore, an image with high contrast can be favorably displayed in an environment with bright external light. Furthermore, the second display element which emits light is used, whereby an image can be favorably displayed in a dark environment. Furthermore, using the insulating film, impurity diffusion between the first display element and the second display element or between the first display element and the pixel circuit can be suppressed. Consequently, a novel display device that is highly convenient or reliable can be provided.

(6) One embodiment of the present invention is the above-described display device, in which the display panel includes a group of pixels, another group of pixels, a scan line, and a signal line.

The group of pixels include the pixel and are provided in the row direction.

The other group of pixels include the pixel and are provided in the column direction that intersects the row direction.

The scan line is electrically connected to the group of pixels, and the signal line is electrically connected to the other group of pixels.

Thus, an image displayed using the first display element and the second display element can have a higher contrast than an image displayed using only the second display element. Consequently, a novel display device that is highly convenient or reliable can be provided.

(7) One embodiment of the present invention is an input/output device including the display device mentioned in any one of the above and an input portion.

The input portion has a function of sensing an object that approaches a region overlapping with the display panel.

(8) One embodiment of the present invention is the above-described input/output device, in which the input portion includes the region overlapping with the display panel.

The input portion includes a control line, a sensor signal line, and a sensing element.

The control line has a function of supplying a control signal.

The sensor signal line has a function of receiving a sensor signal.

The sensing element is electrically connected to the control line and the sensor signal line.

The sensing element has a light-transmitting property. The sensing element includes a first electrode and a second electrode.

The first electrode is electrically connected to the control line.

The second electrode is electrically connected to the sensor signal line and is provided so that an electric field part of which is blocked by an object that approaches the region overlapping with the display panel is generated between the second electrode and the first electrode.

The sensing element has a function of supplying the sensor signal which changes in accordance with the control signal and a distance between the sensing element and an object that approaches the region overlapping with the display panel.

Thus, the object that approaches the region overlapping with the display panel can be sensed while the image data is displayed on the display panel. As a result, a novel input/output device that is highly convenient or reliable can be provided.

(9) One embodiment of the present invention is a data processor including at least one of a keyboard, a hardware button, a pointing device, a touch sensor, an illuminance sensor, an imaging device, an audio input device, a viewpoint input device, and an attitude determination device, and the display device mentioned in any one of the above.

Thus, an arithmetic device can generate image data or control data on the basis of data supplied using a variety of input devices. Furthermore, with the generated image data or control data, the power consumption can be reduced. Furthermore, display with high visibility can be performed even in a bright place. As a result, a novel data processor that is highly convenient or reliable can be provided.

Note that in this specification, a display device or an input/output device includes a structure where a flexible printed circuit is provided, a structure where a tape carrier package is provided, and a structure where an integrated circuit is provided using a chip on glass (COG) method, a chip on film (COF) method, or the like.

Although the block diagram attached to this specification shows components classified by their functions in independent blocks, it is difficult to classify actual components according to their functions completely, and it is possible for one component to have a plurality of functions.

In this specification, the terms “source” and “drain” of a transistor interchange with each other depending on the polarity of the transistor or the levels of potentials applied to the terminals. In general, in an n-channel transistor, a terminal to which a lower potential is applied is called a source, and a terminal to which a higher potential is applied is called a drain. In a p-channel transistor, a terminal to which a lower potential is applied is called a drain, and a terminal to which a higher potential is applied is called a source. In this specification, although connection relation of the transistor is described assuming that the source and the drain are fixed for convenience in some cases, actually, the names of the source and the drain interchange with each other depending on the relation of the potentials.

Note that in this specification, a “source” of a transistor means a source region that is part of a semiconductor film functioning as an active layer or a source electrode connected to the semiconductor film. Similarly, a “drain” of a transistor means a drain region that is part of the semiconductor film or a drain electrode connected to the semiconductor film. A “gate” means a gate electrode.

Note that in this specification, a state in which transistors are connected to each other in series means, for example, a state in which only one of a source and a drain of a first transistor is connected to only one of a source and a drain of a second transistor. In addition, a state in which transistors are connected to each other in parallel means a state in which one of a source and a drain of a first transistor is connected to one of a source and a drain of a second transistor and the other of the source and the drain of the first transistor is connected to the other of the source and the drain of the second transistor.

In this specification, the term “connection” means electrical connection and corresponds to a state where current, voltage, or a potential can be supplied or transmitted. Accordingly, connection means not only direct connection but also indirect connection through a circuit element such as a wiring, a resistor, a diode, or a transistor so that current, voltage, or a potential can be supplied or transmitted.

In this specification, even when different components are connected to each other in a circuit diagram, there is actually a case where one conductive film has functions of a plurality of components such as a case where part of a wiring serves as an electrode. The term “connection” in this specification also means such a case where one conductive film has functions of a plurality of components.

Furthermore, in this specification, one of a first electrode and a second electrode of a transistor refers to a source electrode and the other refers to a drain electrode.

According to one embodiment of the present invention, a novel display device that is highly convenient or reliable is provided. Furthermore, a novel input/output device that is highly convenient or reliable is provided. Furthermore, a novel data processor that is highly convenient or reliable is provided. Furthermore, a novel display device, a novel input/output device, a novel data processor, or a novel semiconductor device is provided.

Note that the description of these effects does not preclude the existence of other effects. One embodiment of the present invention does not necessarily achieve all the effects listed above. Other effects will be apparent from and can be derived from the description of the specification, the drawings, the claims, and the like.

### BRIEF DESCRIPTION OF THE DRAWINGS

In the accompanying drawings:

FIG. 1A is a block diagram illustrating a structure of a display device of one embodiment and FIG. 1B is a schematic view illustrating a structure of a pixel;

FIGS. 2A and 2B each illustrate characteristic curves that can be used for a display device of one embodiment;

FIG. 3A is a schematic view illustrating a structure of a pixel that can be used in a display device of one embodiment and FIG. 3B is a chromaticity diagram illustrating a color gamut that can be expressed by a pixel;

FIG. 4 illustrates the characteristics of a display element that can be used in a display device of one embodiment;

FIGS. 5A and 5B illustrate a structure of a display panel that can be used in a display device of one embodiment;

FIGS. 6A and 6B are cross-sectional views illustrating a structure of a display panel that can be used in a display device of one embodiment;

FIGS. 7A and 7B are cross-sectional views illustrating a structure of a display panel that can be used in a display device of one embodiment;

FIGS. 8A and 8B are bottom views illustrating a structure of a display panel that can be used in a display device of one embodiment;

FIG. 9 is a circuit diagram illustrating a pixel circuit of a display panel that can be used in a display device of one embodiment;

FIGS. 10A to 10C are schematic views each illustrating the shape of a reflective film in a pixel that can be used in a display device of one embodiment;

FIGS. 11A to 11C illustrate a structure of an input/output panel that can be used in an input/output device of one embodiment;

FIGS. 12A and 12B are cross-sectional views illustrating a structure of an input/output panel that can be used in an input/output device of one embodiment;

FIG. 13 is a cross-sectional view illustrating a structure of an input/output panel that can be used in an input/output device of one embodiment;

FIG. 14 is a block diagram illustrating a structure of an input portion that can be used in an input/output device of one embodiment;

FIGS. 15A to 15C are a block diagram and projection views each illustrating a structure of a data processor of one embodiment;

FIGS. 16A and 16B are block diagrams each illustrating a structure of a display portion in a data processor of one embodiment;

FIGS. 17A and 17B are flow charts illustrating a driving method of a data processor of one embodiment;

FIG. 18 is a flow chart illustrating a driving method of a data processor of one embodiment;

FIG. 19 is a flow chart illustrating a driving method of a data processor of one embodiment;

FIGS. 20A to 20H each illustrate a structure of an electronic device of one embodiment;

FIGS. 21A, 21B-1, 21B-2, 21B-3, and 21B-4 illustrate a method for evaluating a display device of an example;

FIGS. 22A and 22B show results of a sensory evaluation of a display device of an example;

FIGS. 23A and 23B show results of a sensory evaluation of a display device of a comparative example; and FIGS. 24A and 24B show results of a sensory evaluation of a display device of a comparative example.

### DETAILED DESCRIPTION OF THE INVENTION

A display device of one embodiment of the present invention includes a display panel and a correction circuit. A pixel of the display panel includes a first display element supplied with a first gray level signal and a second display element supplied with a second gray level signal. The correction circuit has a function of determining a first gray level on the basis of gray level data and a first characteristic curve, and a function of generating and supplying the first gray level signal so that the first gray level is displayed by the first display element. In addition, the correction circuit has a function of determining a second gray level on the basis of the gray level data and a second characteristic curve, and a function of generating and supplying the second gray level signal so that the second gray level is displayed by the second display element. The first characteristic curve has a gamma value greater than 2.2, and the second characteristic curve has a gamma value smaller than that of the first characteristic curve.

Thus, an image displayed using the first display element and the second display element can have a higher contrast than an image displayed using only the second display element. Furthermore, the display using the second display element can be seen from part of the region where the display using the first display element can be seen. Furthermore, users can see display without changing the attitude or the like of the display panel. Consequently, a novel display device that is highly convenient or reliable can be provided.

Embodiments will be described in detail with reference to the drawings. Note that the present invention is not limited to the following description. It will be readily appreciated by those skilled in the art that modes and details of the present invention can be modified in various ways without departing from the spirit and scope of the present invention. Thus, the present invention should not be construed as being limited to the description in the following embodiments and example. Note that in structures of the present invention described below, the same portions or portions having similar functions are denoted by the same reference numerals in different drawings, and a description thereof is not repeated.

### Embodiment 1

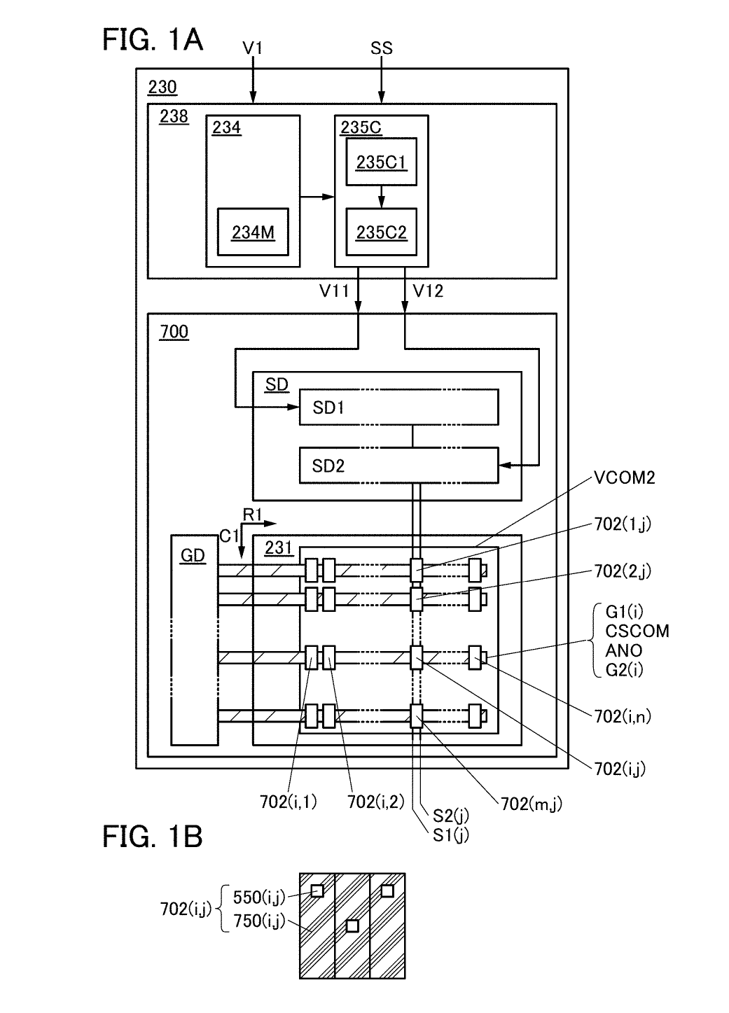

In this embodiment, a structure of a display device of one embodiment of the present invention is described with reference to FIGS. 1A and 1B, FIGS. 2A and 2B, FIGS. 3A and 3B, FIG. 4, FIGS. 5A and 5B, FIGS. 6A and 6B, FIGS. 7A and 7B, FIGS. 8A and 8B, FIG. 9, and FIGS. 10A to 10C.

FIGS. 1A and 1B illustrate the structure of the display device of one embodiment of the present invention. FIG. 1A is a block diagram of the display device of one embodiment of the present invention. FIG. 1B is a schematic view illustrating a structure of a pixel 702(i,j).

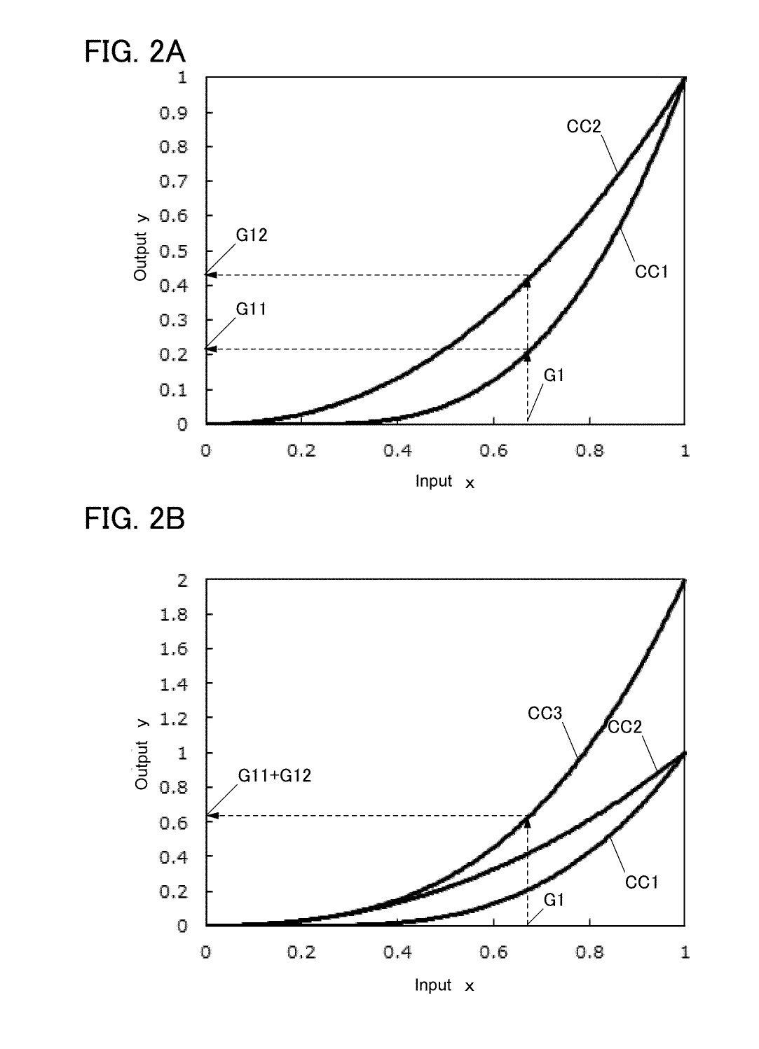

FIGS. 2A and 2B each show characteristic curves that can be used for the display device of one embodiment of the present invention. FIG. 2A shows the characteristic curves used for a correction circuit 235C in the display device of one embodiment of the present invention. FIG. 2B shows the characteristic curves of the display device of one embodiment of the present invention.

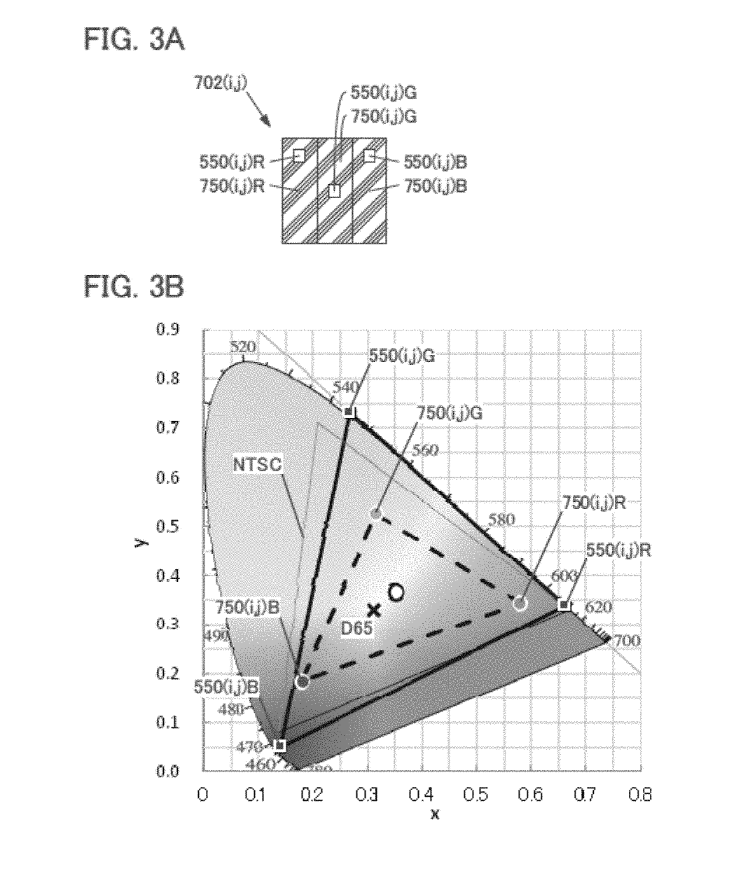

FIG. 3A is a schematic view illustrating a structure of a pixel that can be used in the display device of one embodiment of the present invention. FIG. 3B is a chromaticity diagram showing a color gamut that can be expressed by the pixel illustrated in FIG. 3A.

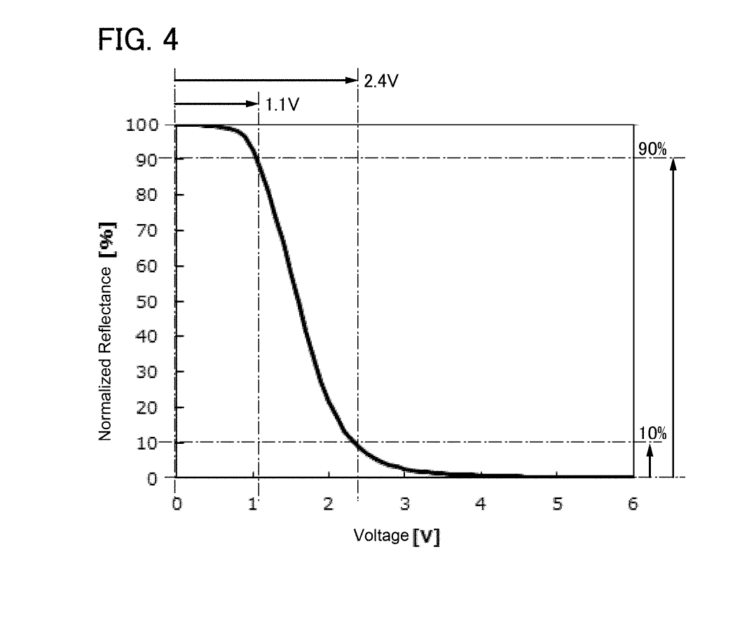

FIG. 4 shows the characteristics of a display element that can be used in the display device of one embodiment of the present invention. Specifically, a characteristic curve shows the normalized reflectance in response to input voltage.

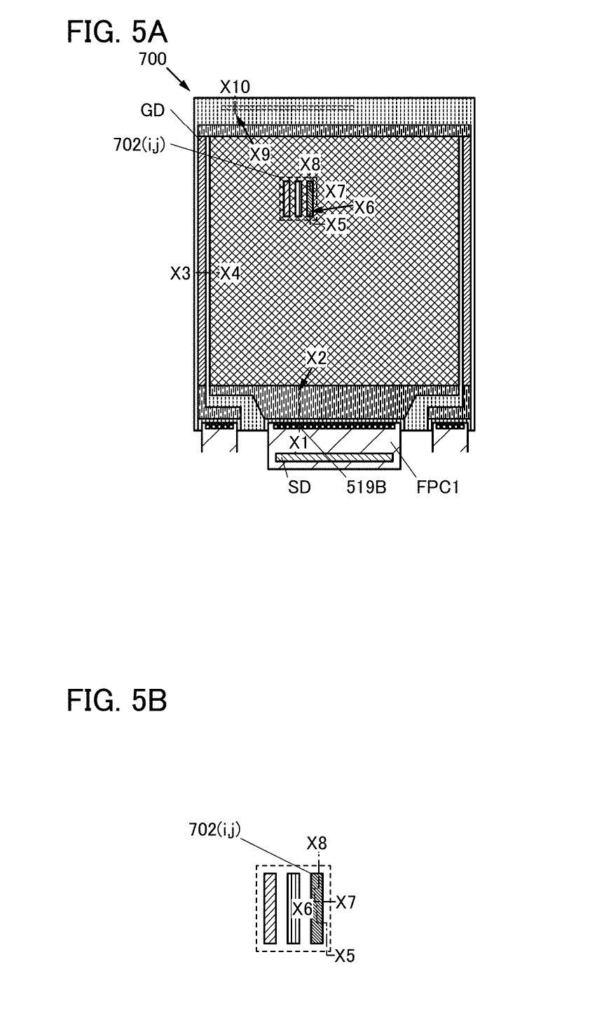

FIGS. 5A and 5B illustrate a structure of a display panel that can be used in the display device of one embodiment of the present invention. FIG. 5A is a top view of the display panel. FIG. 5B is a top view illustrating part of a pixel of the display panel in FIG. 5A.

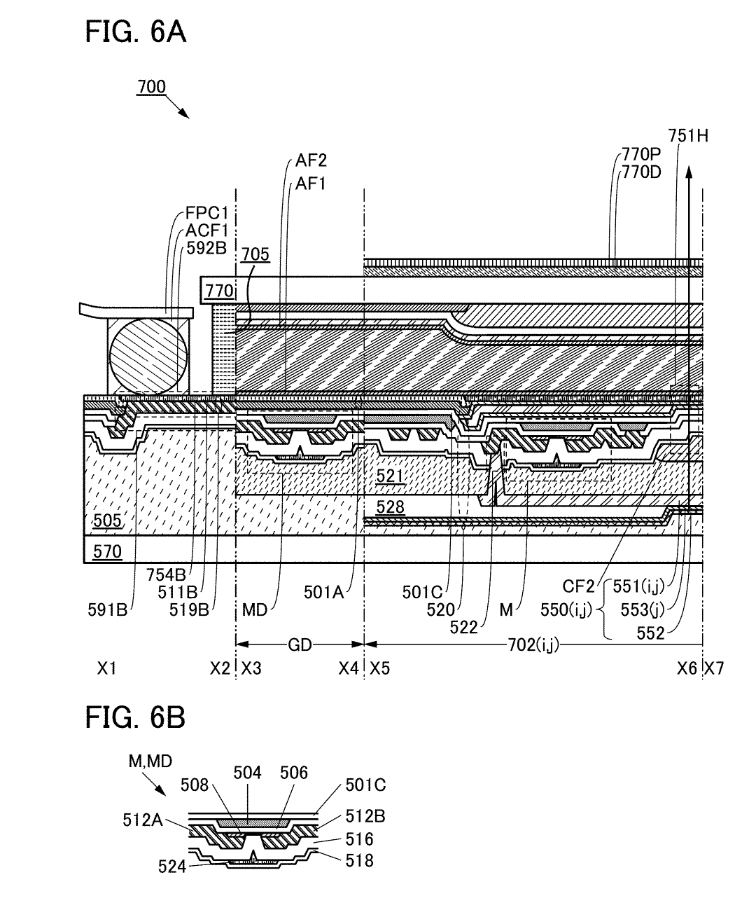

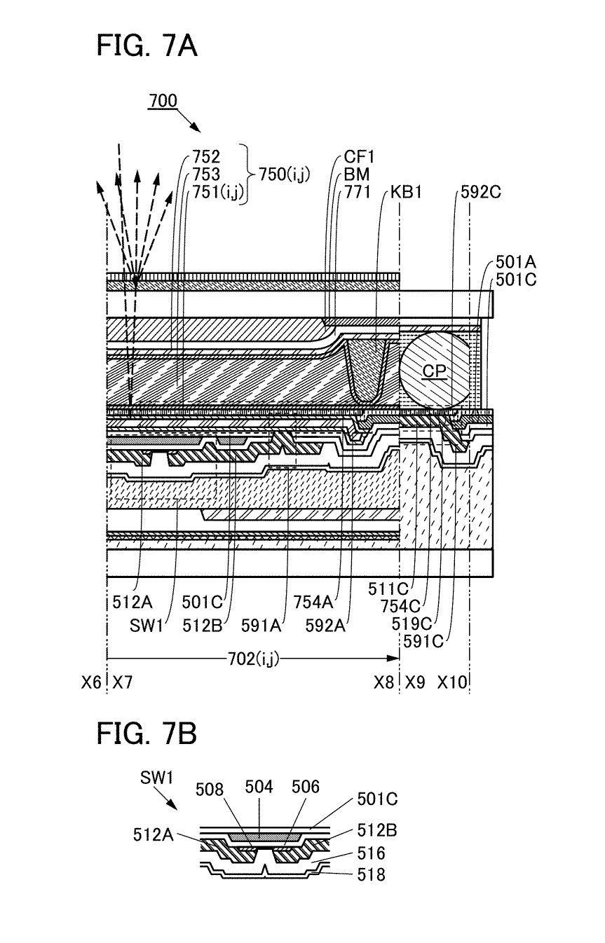

FIGS. 6A and 6B and FIGS. 7A and 7B are cross-sectional views illustrating the structure of the display panel. FIG. 6A is a cross-sectional view taken along the cutting plane lines X1-X2, X3-X4, and X5-X6 in FIG. 5A. FIG. 6B illustrates part of FIG. 6A.

FIG. 7A is a cross-sectional view taken along the cutting plane lines X7-X8 and X9-X10 in FIG. 5A. FIG. 7B illustrates part of FIG. 7A.

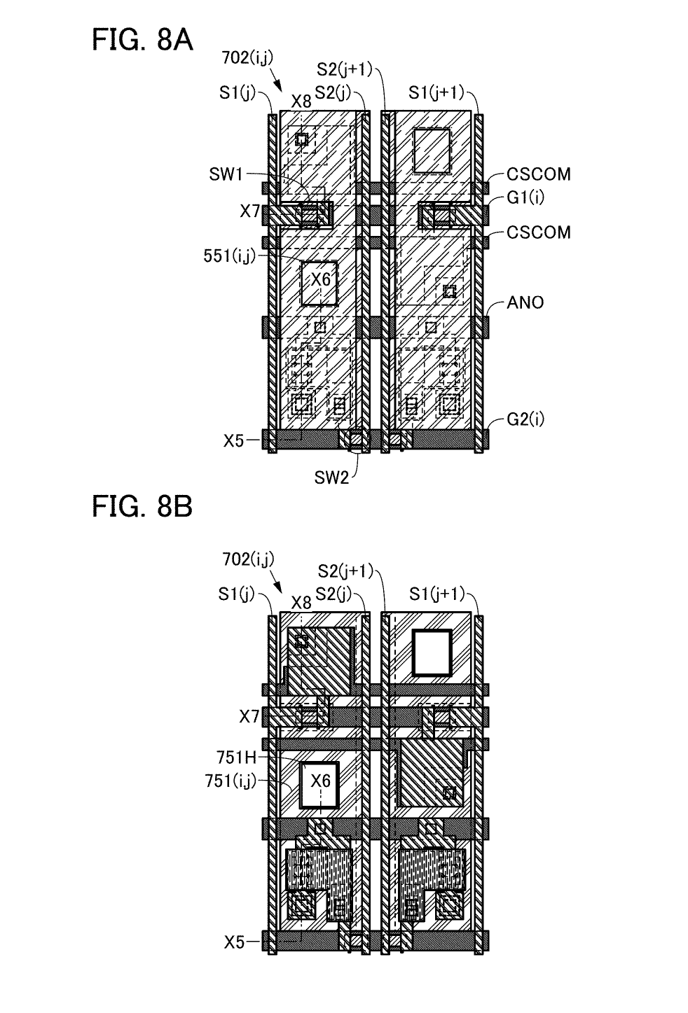

FIG. 8A is a bottom view illustrating part of the pixel of the display panel in FIG. 5B. FIG. 8B is a bottom view illustrating part of the structure in FIG. 8A in which some components are omitted.

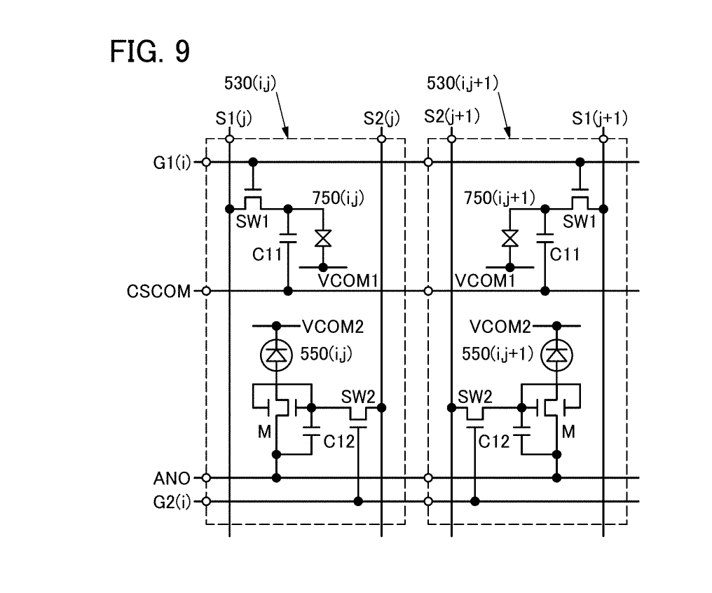

FIG. 9 is a circuit diagram illustrating a structure of a pixel circuit included in the display panel of one embodiment of the present invention.

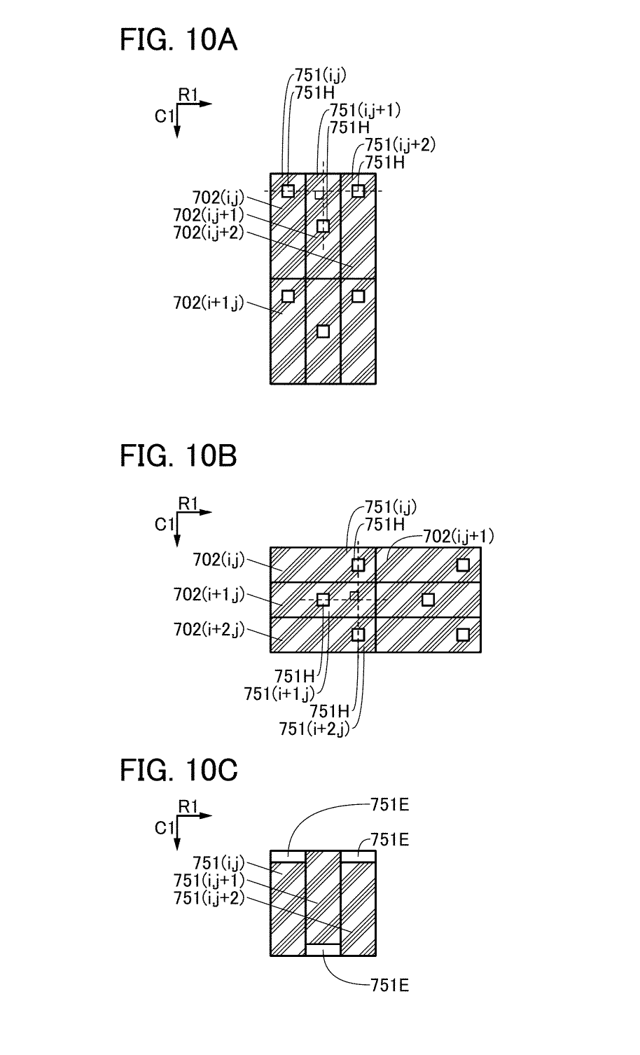

FIGS. 10A to 10C are schematic views each illustrating the shape of a reflective film that can be used in the pixel of the display panel.

Note that in this specification, an integral variable of 1 or more may be used for reference numerals. For example, “(p)” where p is an integral variable of 1 or more may be used for part of a reference numeral that specifies any one of components (p components in maximum). For another example, “(m, n)” where m and n are each an integral variable of 1 or more may be used for part of a reference numeral that specifies any one of components (m×n components in maximum).

### Structure Example 1 of Display Device

The display device described in this embodiment includes a display panel 700 and the correction circuit 235C (see FIG. 1A).

The display panel 700 includes the pixel 702(i,j).

The pixel 702(i,j) includes a first display element 750(i,j) and a second display element 550(i,j) (see FIG. 1B). The second display element 550(i,j) is provided so that display using the second display element 550(i,j) can be seen from part of a region where display using the first display element 750(i,j) can be seen. For example, dashed arrows shown in FIG. 7A denote the directions in which external light is incident on and reflected by the first display element 750(i,j) that performs display by controlling the intensity of external light reflection. In addition, a solid arrow shown in FIG. 6A denotes the direction in which the second display element 550(i,j) emits light to the part of the region where the display using the first display element 750(i,j) can be seen.

The first display element 750(i,j) has a function of receiving a first gray level signal V11. The second display element 550(i,j) has a function of receiving a second gray level signal V12 (see FIG. 1A).

The correction circuit 235C has a function of receiving gray level data G1. For example, image data V1 includes the gray level data G1.

The correction circuit 235C has a function of determining a first gray level G11 on the basis of the gray level data G1 and a first characteristic curve CC1 (see FIG. 2A). In addition, the correction circuit 235C has a function of generating the first gray level signal V11 so that the first gray level G11 is displayed by the first display element 750(i, j), and also has a function of supplying the first gray level signal V11 (see FIG. 1A).

The correction circuit 235C has a function of determining a second gray level G12 on the basis of the gray level data G1 and a second characteristic curve CC2 (see FIG. 2A). In addition, the correction circuit 235C has a function of generating the second gray level signal V12 so that the second gray level G12 is displayed by the second display element 550(i,j), and also has a function of supplying the second gray level signal V12 (see FIG. 1A).

The first characteristic curve CC1 has a gamma value greater than 2.2 in the normalized state. The second characteristic curve CC2 has a gamma value smaller than that of the first characteristic curve CC1 in the normalized state. For example, the following Formula (1) and Formula (2) can be used for the first characteristic curve CC1. Furthermore, the following Formula (3) can be used for the second characteristic curve CC2. Note that in Formulae (1) to (3), x is an input value and y is an output value. The gamma value of the characteristic curve expressed by Formula (2) is 3, and the gamma value of the characteristic curve expressed by Formula (3) is 2.2.

[Formula 1]

y=0(0≦x≦0.2) (1)

y=x³(0.2≦x≦1.0) (2)

y=x^{2.2} (3)

Note that the display device displays the sum of the first gray level G11 displayed by the first display element 750(i,j) and the second gray level G12 displayed by the second display element 550(i,j). For example, when the highest gray level displayed by the second display element 550(i,j) and the highest gray level displayed by the first display element 750(i,j) have the same brightness, the characteristic curve of the display device becomes a characteristic curve CC3 that is obtained by overlapping the characteristic curves CC1 and CC2 (see FIG. 2B).

Thus, an image displayed using the first display element and the second display element can have a higher contrast than an image displayed using only the second display element. Furthermore, the display using the second display element can be seen from part of the region where the display using the first display element can be seen. Furthermore, users can see display without changing the attitude or the like of the display panel. Consequently, a novel display device that is highly convenient or reliable can be provided.

Note that a plurality of subpixels can be used in the pixel 702(i,j) of the display device described in this embodiment (see FIG. 3A).

For example, a first display element 750(i,j)R and a second display element 550(i,j)R can be used in a subpixel that exhibits a red color. Furthermore, a first display element 750(i,j)G and a second display element 550(i,j)G can be used in a subpixel that exhibits a green color. A first display element 750(0B and a second display element 550(i,j)B can be used in a subpixel that exhibits a blue color.

A display element that is farther from a coordinate of white D65 than the first display element 750(i,j)R and that exhibits a brighter color than the first display element 750(i,j)R can be used as the second display element 550(i,j)R, for example (see FIG. 3B). A display element that is farther from a coordinate of white D65 than the first display element 750(i,j)G and that exhibits a brighter color than the first display element 750(i,j)G can be used as the second display element 550(i,j)G. A display element that is farther from a coordinate of white D65 than the first display element 750(i,j)B and that exhibits a brighter color than the first display element 750(i,j)B can be used as the second display element 550(i,j)B.

Furthermore, the second display element 550(i,j)R of the display device described in this embodiment has a function of performing display with higher color purity than the first display element 750(i,j)R (see FIG. 3B).

The first characteristic curve CC1 outputs a value smaller than or equal to 0.01 in response to the input of a value smaller than or equal to 0.2 in the normalized state (see FIG. 2A). For example, when the gray level data G1 includes 256 gray levels, the correction circuit 235C supplied with 50 gray levels on the lower gray level side can output 0 on the basis of the first characteristic curve CC1.

Thus, in a region with low gray level data, an image can be displayed more clearly using the second display element than using the first display element. Furthermore, an image with a wider color gamut can be displayed using the second display element than using the first display element. Consequently, a novel display device that is highly convenient or reliable can be provided.

The first display element 750(i,j) of the display device described in this embodiment has a function of controlling reflectance. The second display element 550(i,j) has a function of controlling emission intensity. A reflective liquid crystal element can be used as the first display element 750(i,j) and an organic electroluminescent element can be used as the second display element 550(i,j), for example.

The first display element 750(i,j) of the display device described in this embodiment includes a first electrode 751(i,j), a second electrode 752, and a layer 753 containing a liquid crystal material (see FIG. 7A).

The second electrode 752 is provided so that an electric field that controls the alignment of the liquid crystal material contained in the layer 753 is generated between the second electrode 752 and the first electrode 751(i,j).

The first display element 750(i,j) has a function of operating in a normally white mode. The first display element 750(i,j) has a voltage that can increase normalized reflectance from lower than 90% to higher than or equal to 90% when a voltage applied between the first electrode 751(i,j) and the second electrode 752 is greater than or equal to 0 V and less than or equal to 1.5 V (see FIG. 4). Note that in the case where the first display element 750(i,j) has a function of operating in a normally white mode, the alignment of the liquid crystal material contained in the layer 753 is controlled so that the first display element 750(i,j) reflects light when no voltage is applied.

The first display element 750(i,j) has a voltage that can increase the normalized reflectance from lower than 10% to higher than or equal to 10% when a voltage applied between the first electrode 751(i,j) and the second electrode 752 is greater than or equal to 0 V and less than or equal to 3.5 V, preferably greater than or equal to 0 V and less than or equal to 2.5 V.

Thus, an image displayed using the second display element and the first display element which utilizes external light incident thereon can have a higher contrast than an image displayed using only the second display element. Specifically, a reflective display element is used as the first display element, whereby the power consumption can be reduced. Furthermore, an image with high contrast can be favorably displayed in an environment with bright external light. Furthermore, the second display element which emits light is used, whereby an image can be favorably displayed in a dark environment. Furthermore, high gray levels can be displayed while power consumption is suppressed. Consequently, a novel display device that is highly convenient or reliable can be provided.

The pixel 702(i,j) of the display device described in this embodiment includes a first conductive film, a second conductive film, an insulating film 501C, and a pixel circuit 530(i,j).

The first conductive film is electrically connected to the first electrode 751(i,j). The second conductive film includes a region overlapping with the first conductive film. For example, the first conductive film can be used for the first electrode 751(i,j) of the first display element 750(i,j).

The insulating film 501C includes a region positioned between the first conductive film and the second conductive film. The insulating film 501C also includes an opening 591A. Furthermore, the insulating film 501C includes a region positioned between an insulating film 501A and a conductive film 511B. Moreover, the insulating film 501C includes an opening 591B in the region positioned between the insulating film 501A and the conductive film 511B. The insulating film 501C includes an opening 591C in a region positioned between the insulating film 501A and a conductive film 511C (see FIG. 6A and FIG. 7A).

The second conductive film is electrically connected to the first conductive film through the opening 591A. For example, the first electrode 751(i,j) is electrically connected to the conductive film 512B. Note that the first conductive film electrically connected to the second conductive film in the opening 591A that is formed in the insulating film 501C can be referred to as a through electrode.

The pixel circuit 530(i,j) is electrically connected to the second conductive film. For example, the conductive film 512B which functions as a source electrode or a drain electrode of a transistor used as a switch SW1 of the pixel circuit 530(i,j) can be used as the second conductive film.

The second display element 550(i,j) is electrically connected to the pixel circuit 530(i,j).

The second display element 550(i,j) has a function of emitting light toward the insulating film 501C (see FIG. 6A).

Thus, the first display element and the second display element that displays an image using a method different from that of the first display element can be driven using pixel circuits that can be formed in the same process. Specifically, a reflective display element is used as the first display element, whereby the power consumption can be reduced. Furthermore, an image with high contrast can be favorably displayed in an environment with bright external light. Furthermore, the second display element which emits light is used, whereby an image can be favorably displayed in a dark environment. Furthermore, using the insulating film, impurity diffusion between the first display element and the second display element or between the first display element and the pixel circuit can be suppressed. Consequently, a novel display device that is highly convenient or reliable can be provided.

The display panel 700 of the display device described in this embodiment includes a group of pixels 702(i,1) to 702(i,n), another group of pixels 702(i,j) to 702(m,j), a scan line G1(i), and a signal line S1(j) (see FIG. 1A). Note that i is an integer greater than or equal to 1 and less than or equal to m, j is an integer greater than or equal to 1 and less than or equal to n, and each of m and n is an integer greater than or equal to 1.

The group of pixels 702(i,1) to 702(i,n) include the pixel 702(i,j) and are provided in the row direction.

The other group of pixels 702(i,j) to 702(m,j) include the pixel 702(i,j) and are provided in the column direction that intersects the row direction.

The scan line G1(i) is electrically connected to the group of pixels 702(i,1) to 702(i,n).

The signal line S1(j) is electrically connected to the other group of pixels 702(1,j) to 702(m,j).

Thus, an image displayed using the first display element and the second display element can have a higher contrast than an image displayed using only the second display element. Consequently, a novel display device that is highly convenient or reliable can be provided.

### <<Display Panel 700>>

The display panel 700 includes the insulating film 501A (see FIG. 6A).

The insulating film 501A includes a first opening 592A, a second opening 592B, and an opening 592C (see FIG. 6A or FIG. 7A).

The first opening 592A includes a region overlapping with a first intermediate film 754A and the first electrode 751(i,j) or a region overlapping with the first intermediate film 754A and the insulating film 501C.

The second opening 592B includes a region overlapping with a second intermediate film 754B and the conductive film 511B. Furthermore, the opening 592C includes a region overlapping with an intermediate film 754C and the conductive film 511C.

The insulating film 501A includes a region that is along an outer edge of the first opening 592A and is between the first intermediate film 754A and the insulating film 501C. The insulating film 501A also includes a region that is along an outer edge of the second opening 592B and is between the second intermediate film 754B and the conductive film 511B.

The display panel 700 includes a scan line G2(i), a wiring CSCOM, a third conductive film ANO, and a signal line S2(j) (see FIGS. 8A and 8B).

The second display element 550(i,j) includes a third electrode 551(i,j), a fourth electrode 552, and a layer 553(j) containing a light-emitting material (see FIG. 6A). Note that the third electrode 551(i,j) and the fourth electrode 552 are electrically connected to the third conductive film ANO and a fourth conductive film VCOM2, respectively (see FIG. 1A).

The fourth electrode 552 includes a region overlapping with the third electrode 551(0.

The layer 553(j) containing a light-emitting material includes a region positioned between the third electrode 551(i,j) and the fourth electrode 552.

The third electrode 551(i,j) is electrically connected to the pixel circuit 530(i,j) at a connection portion 522.

The first display element 750(i,j) includes the layer 753 containing a liquid crystal material, the first electrode 751(i,j), and the second electrode 752. The second electrode 752 is provided so that an electric field that controls the alignment of the liquid crystal material is generated between the second electrode 752 and the first electrode 751(i,j) (see FIG. 6A and FIG. 7A).

The display panel 700 includes an alignment film AF1 and an alignment film AF2. The alignment film AF2 is provided such that the layer 753 containing a liquid crystal material is positioned between the alignment film AF1 and the alignment film AF2.

The display panel 700 includes the first intermediate film 754A and the second intermediate film 754B.

The first intermediate film 754A includes a region which overlaps with the insulating film 501C with the first conductive film interposed therebetween. The first intermediate film 754A includes a region in contact with the first electrode 751(i,j). The second intermediate film 754B includes a region in contact with the conductive film 511B.

The display panel 700 includes a light-blocking film BM, an insulating film 771, a functional film 770P, and a functional film 770D. In addition, a coloring film CF1 and a coloring film CF2 are included.

The light-blocking film BM includes an opening in a region overlapping with the first display element 750(i,j). The coloring film CF2 is provided between the insulating film 501C and the second display element 550(i,j) and includes a region overlapping with an opening 751H (see FIG. 6A).

The insulating film 771 includes a region positioned between the coloring film CF1 and the layer 753 containing a liquid crystal material or between the light-blocking film BM and the layer 753 containing a liquid crystal material. The insulating film 771 can reduce unevenness due to the thickness of the coloring film CF1. Furthermore, the insulating film 771 can prevent impurities from diffusing from the light-blocking film BM, the coloring film CF1, or the like to the layer 753 containing a liquid crystal material

The functional film 770P includes a region overlapping with the first display element 750(i,j).

The functional film 770D includes a region overlapping with the first display element 750(i,j). The functional film 770D is provided such that a substrate 770 is positioned between the functional film 770D and the first display element 750(i,j). Thus, for example, light reflected by the first display element 750(i,j) can be diffused.

The display panel 700 includes a substrate 570, the substrate 770, and a functional layer 520.

The substrate 770 includes a region overlapping with the substrate 570.

The functional layer 520 includes a region positioned between the substrate 570 and the substrate 770. The functional layer 520 includes the pixel circuit 530(i,j), the second display element 550(0, an insulating film 521, and an insulating film 528. Furthermore, the functional layer 520 includes an insulating film 518 and an insulating film 516 (see FIGS. 6A and 6B).

The insulating film 521 includes a region positioned between the pixel circuit 530(i,j) and the second display element 550(i,j).

The insulating film 528 is provided between the insulating film 521 and the substrate 570 and includes an opening in a region overlapping with the second display element 550(i,j).

The insulating film 528 includes a region that is along an outer edge of the third electrode 551(i,j) and covers an end portion of the third electrode 551(i,j). The insulating film 528 has a function of preventing a short circuit between the third electrode 551(i,j) and the fourth electrode.

The insulating film 518 includes a region positioned between the insulating film 521 and the pixel circuit 530(i,j). The insulating film 516 includes a region positioned between the insulating film 518 and the pixel circuit 530(i,j).

The display panel 700 includes a bonding layer 505, a sealant 705, and a structure body KB1.

The bonding layer 505 includes a region positioned between the functional layer 520 and the substrate 570, and has a function of bonding the functional layer 520 and the substrate 570 together.

The sealant 705 includes a region positioned between the functional layer 520 and the substrate 770, and has a function of bonding the functional layer 520 and the substrate 770 together.

The structure body KB1 has a function of providing a certain space between the functional layer 520 and the substrate 770.

The display panel 700 includes a terminal 519B and a terminal 519C.

The terminal 519B includes the conductive film 511B and the intermediate film 754B, and the intermediate film 754B includes a region in contact with the conductive film 511B. The terminal 519B is electrically connected to the signal line S1(j), for example.

The terminal 519C includes the conductive film 511C and the intermediate film 754C, and the intermediate film 754C includes a region in contact with the conductive film 511C. The conductive film 511C is electrically connected to the wiring VCOM1, for example.

A conductive material CP is positioned between the terminal 519C and the second electrode 752, and has a function of electrically connecting the terminal 519C and the second electrode 752. A conductive particle can be used as the conductive material CP, for example.

The display panel 700 includes a driver circuit GD and a driver circuit SD (see FIG. 1A and FIG. 5A).

The driver circuit GD is electrically connected to the scan line G1(i). The driver circuit GD includes a transistor MD, for example (see FIG. 6A). Specifically, a semiconductor film that can be formed in the same process as the semiconductor film of the transistor included in the pixel circuit 530(i,j) can be used for the transistor MD.

The driver circuit SD is electrically connected to the signal line S1(j). The driver circuit SD is electrically connected to the terminal 519B, for example.

### <<Control Portion 238>>

A control portion 238 includes the correction circuit 235C and a decompression circuit 234. In addition, the control portion 238 has a function of receiving the image data V1 and control data SS.

### <<Correction Circuit 235C>>

The correction circuit 235C includes a gamma correction circuit 235C1 and a color correction circuit 235C2.

The gamma correction circuit 235C1 includes a memory portion. The memory portion has a function of storing corrected gray level data or a reference table, for example. The reference table can be used for the first characteristic curve CC1, for example.

The color correction circuit 235C2 includes a memory portion. The memory portion has a function of storing corrected gray level data or a reference table, for example. The reference table can be used for the second characteristic curve CC2, for example.

### <<Decompression Circuit 234>>

The decompression circuit 234 includes a memory portion 234M and has a function of decompressing the compressed image data V1. The memory portion 234M has a function of storing the decompressed image data, for example.

Individual components included in the display device are described below. Note that these components cannot be clearly distinguished and one component may also serve as another component or include part of another component.

For example, the first conductive film can be used as the first electrode 751(0. Furthermore, the first conductive film can be used as a reflective film.

In addition, the second conductive film can be used as the conductive film 512B serving as a source electrode or a drain electrode of a transistor.

### Structure Example

The display panel 700 includes the substrate 570, the substrate 770, the structure body KB1, the sealant 705, or the bonding layer 505.

The display panel 700 also includes the functional layer 520, the insulating film 521, or the insulating film 528.

The display panel 700 also includes the signal line S1(j), the signal line S2(j), the scan line G1(i), the scan line G2(i), the wiring CSCOM, or the third conductive film ANO.

The display panel 700 also includes the first conductive film or the second conductive film.

The display panel 700 also includes the terminal 519B, the terminal 519C, the conductive film 511B, or the conductive film 511C.

The display panel 700 also includes the pixel circuit 530(i,j) or the switch SW1.

The display panel 700 also includes the first display element 750(i,j), the first electrode 751(i,j), the reflective film, the opening, the layer 753 containing a liquid crystal material, or the second electrode 752.

The display panel 700 also includes the alignment film AF1, the alignment film AF2, the coloring film CF1, the coloring film CF2, the light-blocking film BM, the insulating film 771, the functional film 770P, or the functional film 770D.

The display panel 700 also includes the second display element 550(i,j), the third electrode 551(i,j), the fourth electrode 552, or the layer 553(j) containing a light-emitting material.

The display panel 700 also includes the insulating film 501A or the insulating film 501C.

The display panel 700 also includes the driver circuit GD or the driver circuit SD.

### <<Substrate 570>>

The substrate 570 or the like can be formed using a material having heat resistance high enough to withstand heat treatment in the manufacturing process. For example, a material with a thickness greater than or equal to 0.1 mm and less than or equal to 0.7 mm can be used for the substrate 570. Specifically, a material polished to a thickness of approximately 0.1 mm can be used.

For example, a large-sized glass substrate having any of the following sizes can be used as the substrate 570 or the like: the 6th generation (1500 mm×1850 mm), the 7th generation (1870 mm×2200 mm), the 8th generation (2200 mm×2400 mm), the 9th generation (2400 mm×2800 mm), and the 10th generation (2950 mm×3400 mm). Thus, a large-sized display device can be manufactured.

For the substrate 570 or the like, an organic material, an inorganic material, a composite material of an organic material and an inorganic material, or the like can be used. For example, an inorganic material such as glass, ceramics, or metal can be used for the substrate 570 or the like.

Specifically, non-alkali glass, soda-lime glass, potash glass, crystal glass, aluminosilicate glass, tempered glass, chemically tempered glass, quartz, sapphire, or the like can be used for the substrate 570 or the like. Specifically, an inorganic oxide film, an inorganic nitride film, an inorganic oxynitride film, or the like can be used for the substrate 570 or the like. For example, a silicon oxide film, a silicon nitride film, a silicon oxynitride film, an aluminum oxide film, or the like can be used for the substrate 570 or the like. For example, stainless steel, aluminum, or the like can be used for the substrate 570 or the like.

For example, a single crystal semiconductor substrate or a polycrystalline semiconductor substrate of silicon or silicon carbide, a compound semiconductor substrate of silicon germanium or the like, or an SOI substrate can be used as the substrate 570 or the like. Thus, a semiconductor element can be formed over the substrate 570 or the like.

For example, an organic material such as a resin, a resin film, or plastic can be used for the substrate 570 or the like. Specifically, a resin film or resin plate of polyester, polyolefin, polyamide, polyimide, polycarbonate, an acrylic resin, or the like can be used for the substrate 570 or the like.

For example, a composite material formed by attaching a metal plate, a thin glass plate, or a film of an inorganic material to a resin film or the like can be used for the substrate 570 or the like. For example, a composite material formed by dispersing a fibrous or particulate metal, glass, inorganic material, or the like into a resin film can be used for the substrate 570 or the like. For example, a composite material formed by dispersing a fibrous or particulate resin, organic material, or the like into an inorganic material can be used for the substrate 570 or the like.

Furthermore, a single-layer material or a layered material in which a plurality of layers are stacked can be used for the substrate 570 or the like. For example, a layered material in which a base, an insulating film that prevents diffusion of impurities contained in the base, and the like are stacked can be used for the substrate 570 or the like. Specifically, a layered material in which glass and one or a plurality of films that are selected from a silicon oxide layer, a silicon nitride layer, a silicon oxynitride layer, and the like and that prevent diffusion of impurities contained in the glass are stacked can be used for the substrate 570 or the like. Alternatively, a layered material in which a resin and a film for preventing diffusion of impurities that penetrate the resin, such as a silicon oxide film, a silicon nitride film, and a silicon oxynitride film are stacked can be used for the substrate 570 or the like.

Specifically, a resin film, a resin plate, a stacked-layer material, or the like containing polyester, polyolefin, polyamide, polyimide, polycarbonate, an acrylic resin, or the like can be used for the substrate 570 or the like.

Specifically, a material including polyester, polyolefin, polyamide (e.g., nylon or aramid), polyimide, polycarbonate, polyurethane, an acrylic resin, an epoxy resin, a resin having a siloxane bond, such as silicone, or the like can be used for the substrate 570 or the like.

Specifically, polyethylene terephthalate (PET), polyethylene naphthalate (PEN), polyethersulfone (PES), acrylic, or the like can be used for the substrate 570 or the like.

Alternatively, paper, wood, or the like can be used for the substrate 570 or the like.

For example, a flexible substrate can be used as the substrate 570 or the like.

Note that a transistor, a capacitor, or the like can be directly formed on the substrate. Alternatively, a transistor, a capacitor, or the like formed over a substrate for use in manufacturing processes which can withstand heat applied in the manufacturing process can be transferred to the substrate 570 or the like. Thus, a transistor, a capacitor, or the like can be formed over a flexible substrate, for example.

### <<Substrate 770>>

A light-transmitting material can be used for the substrate 770, for example. Specifically, any of the materials that can be used for the substrate 570 can be used for the substrate 770.

For example, aluminosilicate glass, tempered glass, chemically tempered glass, sapphire, or the like can be favorably used for the substrate 770 that is on a side closer to a user of the display panel. This can prevent breakage or damage of the display panel caused by the use.

A material with a thickness greater than or equal to 0.1 mm and less than or equal to 0.7 mm can be used for the substrate 770, for example. Specifically, a substrate polished to reduce the thickness can be used. In that case, the functional film 770D can be close to the first display element 750(0. As a result, image blur can be reduced and an image can be displayed clearly.

<<Structure body KB1>>

The structure body KB1 or the like can be formed using an organic material, an inorganic material, or a composite material of an organic material and an inorganic material. Thus, a predetermined space can be provided between components between which the structure body KB1 and the like are provided.

Specifically, for the structure body KB1, polyester, polyolefin, polyamide, polyimide, polycarbonate, polysiloxane, an acrylic resin, or the like, or a composite material of a plurality of resins selected from these can be used. Alternatively, a photosensitive material may be used.

### <<Sealant 705>>

For the sealant 705 or the like, an inorganic material, an organic material, a composite material of an inorganic material and an organic material, or the like can be used.

For example, an organic material such as a thermally fusible resin or a curable resin can be used for the sealant 705 or the like.

For the sealant 705 or the like, an organic material such as a reactive curable adhesive, a light curable adhesive, a thermosetting adhesive, and/or an anaerobic adhesive can be used.

Specifically, an adhesive containing an epoxy resin, an acrylic resin, a silicone resin, a phenol resin, a polyimide resin, an imide resin, a polyvinyl chloride (PVC) resin, a polyvinyl butyral (PVB) resin, an ethylene vinyl acetate (EVA) resin, or the like can be used for the sealant 705 or the like.

### <<Bonding Layer 505>>

For the bonding layer 505, any of the materials that can be used for the sealant 705 can be used, for example.

### <<Insulating Film 521>>

For the insulating film 521 or the like, an insulating inorganic material, an insulating organic material, or an insulating composite material containing an inorganic material and an organic material can be used, for example.

Specifically, an inorganic oxide film, an inorganic nitride film, an inorganic oxynitride film, or a layered material obtained by stacking any of these films can be used as the insulating film 521 or the like. For example, a film including any of a silicon oxide film, a silicon nitride film, a silicon oxynitride film, and an aluminum oxide film, or a film including a material obtained by stacking any of these films can be used for the insulating film 521 or the like.

Specifically, polyester, polyolefin, polyamide, polyimide, polycarbonate, polysiloxane, an acrylic resin, or the like, or a layered or composite material including resins selected from these, or the like can be used for the insulating film 521 or the like. Alternatively, a photosensitive material may be used.

Thus, steps due to various components overlapping with the insulating film 521, for example, can be reduced.

### <<Insulating Film 528>>

For the insulating film 528 or the like, any of the materials that can be used for the insulating film 521 can be used, for example. Specifically, a 1-μm-thick polyimide-containing film can be used as the insulating film 528.

### <<Insulating Film 501A>>

For the insulating film 501A, any of the materials that can be used for the insulating film 521 can be used, for example. Alternatively, for example, a material having a function of supplying hydrogen can be used for the insulating film 501A.

Specifically, a material in which a material containing silicon and oxygen and a material containing silicon and nitrogen are stacked can be used for the insulating film 501A. For example, a material having a function of releasing hydrogen by heating or the like to supply the hydrogen to another component can be used for the insulating film 501A. Specifically, a material having a function of releasing hydrogen taken in the manufacturing process, by heating or the like, to supply the hydrogen to another component can be used for the insulating film 501A.

For example, a film containing silicon and oxygen that is formed by a chemical vapor deposition method using silane or the like as a source gas can be used as the insulating film 501A.

Specifically, a material obtained by stacking a material containing silicon and oxygen and having a thickness of more than or equal to 200 nm and less than or equal to 600 nm and a material containing silicon and nitrogen and having a thickness of approximately 200 nm can be used for the insulating film 501A.

### <<Insulating Film 501C>>

For the insulating film 501C, any of the materials that can be used for the insulating film 521 can be used, for example. Specifically, a material containing silicon and oxygen can be used for the insulating film 501C. Thus, diffusion of impurities into the pixel circuit, the second display element, or the like can be inhibited.

For example, a 200-nm-thick film containing silicon, oxygen, and nitrogen can be used as the insulating film 501C.

### <<Intermediate Film 754A, Intermediate Film 754B, Intermediate Film 754C>>

A film with a thickness greater than or equal to 10 nm and less than or equal to 500 nm, preferably greater than or equal to 10 nm and less than or equal to 100 nm, can be used for the intermediate film 754A, the intermediate film 754B, or the intermediate film 754C, for example. Note that in this this specification, the intermediate film 754A, the intermediate film 754B, or the intermediate film 754C is referred to as an intermediate film.

For example, a material having a function of allowing hydrogen passage and supplying hydrogen can be used for the intermediate film.

For example, a conductive material can be used for the intermediate film.

For example, a light-transmitting material can be used for the intermediate film.

Specifically, a material containing indium and oxygen, a material containing indium, gallium, zinc, and oxygen, a material containing indium, tin, and oxygen, or the like can be used for the intermediate film. Note that the above material is permeable to hydrogen.

Specifically, a 50- or 100-nm-thick film containing indium, gallium, zinc, and oxygen can be used as the intermediate film.

Note that a material in which films serving as etching stoppers are stacked can be used for the intermediate film. Specifically, a material in which a 50-nm-thick film containing indium, gallium, zinc, and oxygen and a 20-nm-thick film containing indium, tin, and oxygen, are stacked in this order can be used for the intermediate film.

### <<Wiring, Terminal, Conductive Film>>

A conductive material can be used for the wiring or the like. Specifically, the conductive material can be used for the signal line S1(j), the signal line S2(j), the scan line G1(i), the scan line G2(i), the wiring CSCOM, the third conductive film ANO, the terminal 519B, the terminal 519C, the conductive film 511B, the conductive film 511C, or the like.

For example, an inorganic conductive material, an organic conductive material, a metal material, a conductive ceramic material, or the like can be used for the wiring or the like.

Specifically, a metal element selected from aluminum, gold, platinum, silver, copper, chromium, tantalum, titanium, molybdenum, tungsten, nickel, iron, cobalt, palladium, and manganese can be used for the wiring or the like. Alternatively, an alloy including any of the above-described metal elements, or the like can be used for the wiring or the like. In particular, an alloy of copper and manganese is suitably used in microfabrication with the use of a wet etching method.

Specifically, any of the following structures can be used for the wiring or the like: a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure in which a titanium film, an aluminum film, and a titanium film are stacked in this order, and the like.

Specifically, a conductive oxide such as indium oxide, indium tin oxide, indium zinc oxide, zinc oxide, or zinc oxide to which gallium is added can be used for the wiring or the like.

Specifically, a film containing graphene or graphite can be used for the wiring or the like.

For example, a film including graphene oxide is formed and is subjected to reduction, so that a film including graphene can be formed. As a reducing method, a method using heat, a method using a reducing agent, or the like can be employed.

A film containing a metal nanowire can be used for the wiring or the like, for example. Specifically, a nanowire containing silver can be used.

Specifically, a conductive high molecule can be used for the wiring or the like.

Note that the terminal 519B can be electrically connected to a flexible printed circuit FPC1 using a conductive material ACF1, for example.

### <<First Conductive Film, Second Conductive Film>>

For the first conductive film or the second conductive film, any of the materials that can be used for the wiring or the like can be used, for example.

The first electrode 751(i,j), the wiring, or the like can be used for the first conductive film.

The conductive film 512B functioning as the source electrode or the drain electrode of the transistor that can be used as the switch SW1, or the wiring or the like can be used for the second conductive film.

<<Pixel Circuit 530(i,j)>>

The pixel circuit 530(i,j) is electrically connected to the signal line S1(j), the signal line S2(j), the scan line G1(i), the scan line G2(i), the wiring CSCOM, and the third conductive film ANO (see FIG. 9). Note that the conductive film 512A is electrically connected to the signal line S1(j) (see FIG. 7A and FIG. 9). Furthermore, for example, the transistor in which the second conductive film is used as the conductive film 512B serving as a source electrode or a drain electrode can be used as the switch SW1 of the pixel circuit 530(i,j).

The pixel circuit 530(i,j) includes the switch SW1 and a capacitor C11 (see FIG. 9).

The pixel circuit 530(i,j) includes a switch SW2, a transistor M, and a capacitor C12.

For example, a transistor including a gate electrode electrically connected to the scan line G1 (i) and a first electrode electrically connected to the signal line 510 can be used as the switch SW1.

The capacitor C11 includes a first electrode electrically connected to a second electrode of the transistor used as the switch SW1 and a second electrode electrically connected to the wiring CSCOM.

For example, a transistor including a gate electrode electrically connected to the scan line G2(i) and a first electrode electrically connected to the signal line S20 can be used as the switch SW2.

The transistor M includes a gate electrode electrically connected to the second electrode of the transistor used as the switch SW2 and a first electrode electrically connected to the third conductive film ANO.

Note that a transistor including a conductive film provided such that a semiconductor film is interposed between a gate electrode and the conductive film can be used as the transistor M. For example, as the conductive film, a conductive film electrically connected to a wiring that can supply the same potential as that of the gate electrode of the transistor M can be used.

The capacitor C12 includes a first electrode electrically connected to a second electrode of the transistor used as the switch SW2 and a second electrode electrically connected to the first electrode of the transistor M.

Note that the first electrode and the second electrode of the first display element 750(i,j) are electrically connected to the second electrode of the transistor used as the switch SW1 and the wiring VCOM1, respectively. This enables the first display element 750(i,j) to be driven.

Furthermore, the first electrode and the second electrode of the second display element 550(i,j) are electrically connected to the second electrode of the transistor M and the fourth conductive film VCOM2, respectively. This enables the second display element 550(i,j) to be driven.

### <<Switch SW1, Switch SW2, Transistor M, Transistor MD>>

As the switch SW1, the switch SW2, the transistor M, the transistor MD, or the like, a bottom-gate transistor, a top-gate transistor, or the like can be used, for example.

For example, a transistor including a semiconductor containing an element belonging to Group 14 in a semiconductor film can be used. Specifically, a semiconductor containing silicon can be used for the semiconductor film. For example, single crystal silicon, polysilicon, microcrystalline silicon, amorphous silicon, or the like can be used for the semiconductor film of the transistor.

For example, a transistor including an oxide semiconductor in a semiconductor film can be used. Specifically, an oxide semiconductor containing indium or an oxide semiconductor containing indium, gallium, and zinc can be used for a semiconductor film.

For example, a transistor whose leakage current in an off state is smaller than that of a transistor including amorphous silicon in a semiconductor film can be used as the switch SW1, the switch SW2, the transistor M, the transistor MD, or the like. Specifically, a transistor including an oxide semiconductor in a semiconductor film 508 can be used as the switch SW1, the switch SW2, the transistor M, the transistor MD, or the like.

Thus, a pixel circuit can hold an image signal for a longer time than a pixel circuit including a transistor that uses amorphous silicon for a semiconductor film. Specifically, a selection signal can be supplied at a frequency of lower than 30 Hz, preferably lower than 1 Hz, further preferably less than once per minute while flickering is suppressed. Consequently, eyestrain on a user of the data processor can be reduced, and power consumption for driving can be reduced.

The transistor that can be used as the switch SW1 includes the semiconductor film 508 and a conductive film 504 that includes a region overlapping with the semiconductor film 508 (see FIG. 7B). The transistor that can be used as the switch SW1 includes the conductive film 512A and the conductive film 512B, which are electrically connected to the semiconductor film 508.

Note that the conductive film 504 and an insulating film 506 serve as a gate electrode and a gate insulating film, respectively. The conductive film 512A has one of a function as a source electrode and a function as a drain electrode, and the conductive film 512B has the other.

A transistor in which the semiconductor film 508 is provided between the conductive film 504 and a conductive film 524 can be used as the transistor M (see FIG. 6B).

A conductive film in which a 10-nm-thick film containing tantalum and nitrogen and a 300-nm-thick film containing copper are stacked from the insulating film 501C side can be used as the conductive film 504, for example.

A material obtained by stacking a 400-nm-thick film containing silicon and nitrogen and a 200-nm-thick film containing silicon, oxygen, and nitrogen can be used for the insulating film 506, for example.

A 25-nm-thick film containing indium, gallium, and zinc can be used as the semiconductor film 508, for example.

A conductive film in which a 50-nm-thick film containing tungsten, a 400-nm-thick film containing aluminum, and a 100-nm-thick film containing titanium are stacked from the insulating film 501C side can be used as the conductive film 512A or 512B, for example.

<<First Display Element 750(i,j)>>

As the first display element 750(i,j) or the like, a display element having a function of controlling transmission or reflection of light can be used. For example, a combined structure of a polarizing plate and a liquid crystal element or a MEMS shutter display element can be used. Specifically, a reflective liquid crystal display element can be used as the first display element 750(i,j). The use of a reflective display element can reduce power consumption of a display panel.

A liquid crystal element driven by any of the following driving modes can be used, for example: an in-plane switching (IPS) mode, a twisted nematic (TN) mode, a fringe field switching (FFS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, and the like.

In addition, a liquid crystal element that can be driven by, for example, a vertical alignment (VA) mode such as a multi-domain vertical alignment (MVA) mode, a patterned vertical alignment (PVA) mode, an electrically controlled birefringence (ECB) mode, a continuous pinwheel alignment (CPA) mode, or an advanced super view (ASV) mode can be used.

The first display element 750(i,j) includes a first electrode, a second electrode, and a layer containing a liquid crystal material. The layer containing a liquid crystal material contains a liquid crystal material whose orientation is controlled by voltage applied between the first electrode and the second electrode. For example, the orientation of the liquid crystal material can be controlled by an electric field in the thickness direction of the layer containing a liquid crystal material (also referred to as the vertical direction) or an electric field in the direction intersecting the vertical direction (also referred to as the horizontal direction or the diagonal direction).

### <<Layer 753 Containing Liquid Crystal Material>>

A thermotropic liquid crystal, a low-molecular liquid crystal, a high-molecular liquid crystal, a polymer dispersed liquid crystal, a ferroelectric liquid crystal, an anti-ferroelectric liquid crystal, or the like can be used for the layer 753 containing a liquid crystal material, for example. Alternatively, a liquid crystal material that exhibits a cholesteric phase, a smectic phase, a cubic phase, a chiral nematic phase, an isotropic phase, or the like can be used. Alternatively, a liquid crystal material that exhibits a blue phase can be used.

<<First Electrode 751(i,j)>>

The material of the wiring or the like can be used for the first electrode 751(i,j), for example. Specifically, a reflective film can be used for the first electrode 751(i,j). For example, a material in which a light-transmitting conductive material and a reflective film including an opening are stacked can be used for the first electrode 751(i,j).

### <<Reflective Film>>

The reflective film has a shape including a region that does not block light emitted from the second display element 550(i,j), for example. The reflective film includes the opening 751H, for example.

The opening 751H of the pixel 702(i,j+1), which is adjacent to the pixel 702(i,j), is not provided on a line that extends in the row direction (the direction indicated by an arrow R1 in the drawing) through the opening 751H of the pixel 702(i,j) (see FIG. 10A). Alternatively, for example, the opening 751H of the pixel 702(i+1,j), which is adjacent to the pixel 702(0, is not provided on a line that extends in the column direction (the direction indicated by an arrow C1 in the drawing) through the opening 751H of the pixel 702(i,j) (see FIG. 10B).

For example, the opening 751H of the pixel 702(i,j+2) is provided on a line that extends in the row direction through the opening 751H of the pixel 702(i,j) (see FIG. 10A). In addition, the opening 751H of the pixel 702(i,j+1) is provided on a line that is perpendicular to the above-mentioned line between the opening 751H of the pixel 702(i,j) and the opening 751H of the pixel 702(i,j+2).

Alternatively, for example, the opening 751H of the pixel 702(i+2,j) is provided on a line that extends in the column direction through the opening 751H of the pixel 702(i,j) (see FIG. 10B). In addition, for example, the opening 751H of the pixel 702(i+1,j) is provided on a line that is perpendicular to the above-mentioned line between the opening 751H of the pixel 702(i,j) and the opening 751H of the pixel 702(i+2, j).

Thus, a second display element that includes a region overlapping with an opening of a pixel adjacent to one pixel can be apart from a second display element that includes a region overlapping with an opening of the one pixel. Furthermore, a display element that exhibits color different from that exhibited by the second display element of the one pixel can be provided as the second display element of the pixel adjacent to the one pixel. Furthermore, the difficulty in adjacently arranging a plurality of display elements that exhibit different colors can be lowered. As a result, a novel display panel that is highly convenient or reliable can be provided.

For example, the reflective film can be formed using a material having a shape in which an end portion is cut off so as to form a region 751E that does not block light emitted from the second display element 550(i,j) (see FIG. 10C). Specifically, the first electrode 751(i,j) whose end portion is cut off so as to be shorter in the column direction (the direction indicated by the arrow C1 in the drawing) can be used as the reflective film.

For example, a material that reflects visible light can be used for the reflective film. Specifically, a material containing silver can be used for the reflective film. For example, a material containing silver, palladium, and the like or a material containing silver, copper, and the like can be used for the reflective film.

The reflective film reflects light that passes through the layer 753 containing a liquid crystal material, for example. This allows the first display element 750 to serve as a reflective liquid crystal element. Furthermore, for example, a material with an uneven surface can be used for the reflective film. In that case, incident light can be reflected in various directions so that a white image can be displayed.

Note that the first electrode 751(i,j) is not necessarily used for the reflective film. For example, a structure in which the reflective film is provided between the layer 753 containing a liquid crystal material and the first electrode 751(i,j) can be used. Alternatively, a structure in which the first electrode 751(i,j) having a light-transmitting property is provided between the reflective film and the layer 753 containing a liquid crystal material can be used.

### <<Opening 751H, Region 751E>>

The opening 751H or the region 751E may have a polygonal shape, a quadrangular shape, an elliptical shape, a circular shape, a cross-like shape, a stripe shape, a slit-like shape, or a checkered pattern, for example.

Furthermore, a single opening or a group of openings can be used as the opening 751H.

If the ratio of the total area of the opening 751H to the total area except for the opening is too high, display performed using the first display element 750(i,j) is dark.

If the ratio of the total area of the opening 751H to the total area except for the opening is too low, display performed using the second display element 550(i,j) is dark.

### <<Second Electrode 752>>

A material having a visible-light-transmitting property and conductivity can be used for the second electrode 752, for example.

For example, a conductive oxide, a metal film thin enough to transmit light, or a metal nanowire can be used for the second electrode 752.

Specifically, a conductive oxide containing indium can be used for the second electrode 752. Alternatively, a metal thin film with a thickness greater than or equal to 1 nm and less than or equal to 10 nm can be used for the second electrode 752. Alternatively, a metal nanowire containing silver can be used for the second electrode 752.

Specifically, indium oxide, indium tin oxide, indium zinc oxide, zinc oxide, zinc oxide to which gallium is added, zinc oxide to which aluminum is added, or the like can be used for the second electrode 752.

### <<Alignment Film AF1, Alignment Film AF2>>

The alignment film AF1 or the alignment film AF2 can be formed using a material containing polyimide or the like, for example. Specifically, a material formed by rubbing treatment or an optical alignment technique such that a liquid crystal material has a predetermined alignment can be used.

For example, a film containing soluble polyimide can be used for the alignment film AF1 or the alignment film AF2. In this case, the temperature required in forming the alignment film AF1 or the alignment film AF2 can be low. Accordingly, damage to other components at the time of forming the alignment film AF1 or the alignment film AF2 can be reduced.

### <<Coloring Film CF1, Coloring Film CF2>>

A material that transmits light of a predetermined color can be used for the coloring film CF1 or the coloring film CF2. In that case, the coloring film CF1 or the coloring film CF2 can be used as a color filter, for example. For example, a material that transmits blue light, green light, or red light can be used for the coloring film CF1 or the coloring film CF2. Furthermore, a material that transmits yellow light, white light, or the like can be used for the coloring film CF1 or the coloring film CF2.

Note that a material having a function of converting the emitted light into a predetermined color light can be used for the coloring film CF2. Specifically, quantum dots can be used for the coloring film CF2. Thus, display with high color purity can be achieved.

### <<Light-Blocking Film BM>>

The light-blocking film BM can be formed with a material that prevents light transmission and thus can be used as a black matrix, for example.

### <<Insulating Film 771>>

The insulating film 771 can be formed of polyimide, an epoxy resin, an acrylic resin, or the like.

### <<Functional Film 770P, Functional Film 770D>>

An anti-reflection film, a polarizing film, a retardation film, a light diffusion film, a condensing film, or the like can be used as the functional film 770P or the functional film 770D, for example.

Specifically, a film containing a dichromatic pigment can be used as the functional film 770P or the functional film 770D. Alternatively, a material with a columnar structure having an axis along the direction intersecting a surface of a base can be used for the functional film 770P or the functional film 770D. In that case, light can be transmitted in the direction along the axis and scattered in other directions easily.

Alternatively, an antistatic film preventing the attachment of a foreign substance, a water repellent film suppressing the attachment of stain, a hard coat film suppressing a scratch in use, or the like can be used as the functional film 770P.

Specifically, a circularly polarizing film can be used as the functional film 770P. Furthermore, a light diffusion film can be used as the functional film 770D.

<<Second Display Element 550(i,j)>>

A light-emitting element can be used as the second display element 550(i,j), for example. Specifically, an organic electroluminescent element, an inorganic electroluminescent element, a light-emitting diode, or the like can be used as the second display element 550(i,j).

For example, a light-emitting organic compound can be used for the layer 5530 containing a light-emitting material.

For example, quantum dots can be used for the layer 553(j) containing a light-emitting material. Accordingly, the half width becomes narrow, and light of a bright color can be emitted.

A layered material for emitting blue light, green light, or red light can be used for the layer 553(j) containing a light-emitting material, for example.

For example, a belt-like layered material that extends in the column direction along the signal line S2(j) can be used for the layer 553(j) containing a light-emitting material.

Alternatively, a layered material for emitting white light can be used for the layer 553(j) containing a light-emitting material. Specifically, a layered material in which a layer containing a light-emitting material including a fluorescent material that emits blue light, and a layer containing a material that is other than a fluorescent material and that emits green light and red light or a layer containing a material that is other than a fluorescent material and that emits yellow light are stacked can be used for the layer 553(j) containing a light-emitting material.

For example, a material that can be used for the wiring or the like can be used for the third electrode 551(i,j).

For example, a material that transmits visible light and is selected from the materials used for the wiring or the like can be used for the third electrode 551(i,j).

Specifically, conductive oxide, indium-containing conductive oxide, indium oxide, indium tin oxide, indium zinc oxide, zinc oxide, zinc oxide to which gallium is added, or the like can be used for the third electrode 551(i,j). Alternatively, a metal film that is thin enough to transmit light can be used for the third electrode 551(i,j). Further alternatively, a metal film that transmits part of light and reflects another part of light can be used for the third electrode 551(i,j). Accordingly, the second display element 550(i,j) can have a microcavity structure. As a result, light of a predetermined wavelength can be extracted more efficiently than light of other wavelengths.

A material that can be used for the wiring or the like can be used for the fourth electrode 552, for example. Specifically, a material that reflects visible light can be used for the fourth electrode 552.

### <<Driver Circuit GD>>

Any of a variety of sequential circuits, such as a shift register, can be used as the driver circuit GD. For example, the transistor MD, a capacitor, and the like can be used in the driver circuit GD. Specifically, a transistor including a semiconductor film that can be formed in the same process as the semiconductor film of the transistor M or the transistor that can be used as the switch SW1 can be used.

As the transistor MD, a transistor having a different structure from the transistor that can be used as the switch SW1 can be used, for example. Specifically, a transistor including the conductive film 524 can be used as the transistor MD (see FIG. 6B).

The semiconductor film 508 is provided between the conductive films 524 and 504. The insulating film 516 is provided between the conductive film 524 and the semiconductor film 508. The insulating film 506 is provided between the semiconductor film 508 and the conductive film 504. For example, the conductive film 524 is electrically connected to a wiring supplying the same potential as that supplied to the conductive film 504.

Note that the transistor MD can have the same structure as the transistor M.

Note that this embodiment can be combined with any of the other embodiments in this specification as appropriate.

### Embodiment 2

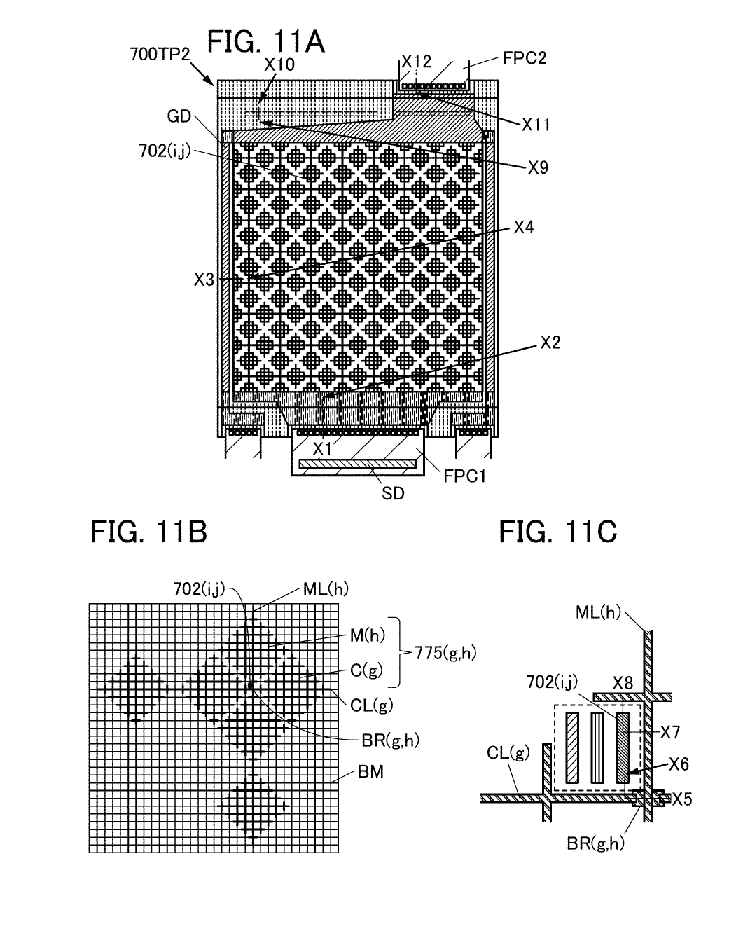

In this embodiment, a structure of an input/output device of one embodiment of the present invention is described with reference to FIGS. 11A to 11C, FIGS. 12A and 12B, FIG. 13, and FIG. 14.

FIGS. 11A to 11C illustrate a structure of an input/output panel that can be used in the input/output device of one embodiment of the present invention. FIG. 11A is a top view of the input/output panel. FIG. 11B is a schematic view illustrating part of an input portion of the input/output panel. FIG. 11C is a schematic view illustrating part of the structure in FIG. 11B.

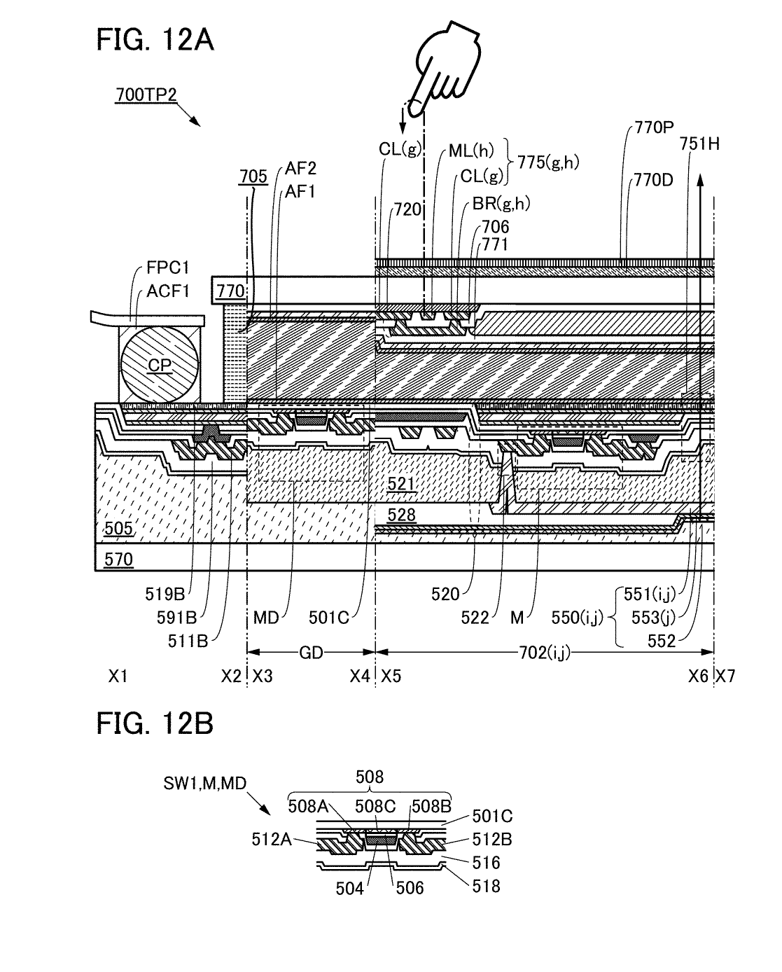

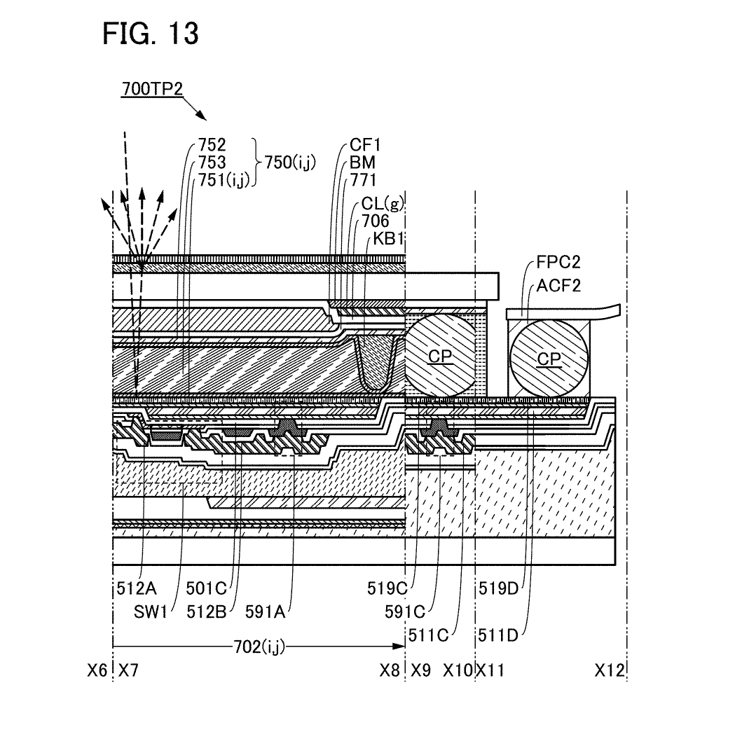

FIGS. 12A and 12B and FIG. 13 illustrate the structure of the input/output panel that can be used in the input/output device of one embodiment of the present invention. FIG. 12A is a cross-sectional view taken along cutting plane lines X1-X2 and X3-X4 in FIG. 11A and a cutting plane line X5-X6 in FIG. 11C. FIG. 12B is a cross-sectional view illustrating part of the structure in FIG. 12A.

FIG. 13 is a cross-sectional view taken along the cutting plane line X7-X8 in FIG. 11C and the cutting plane lines X9-X10 and X11-X12 in FIG. 11A.

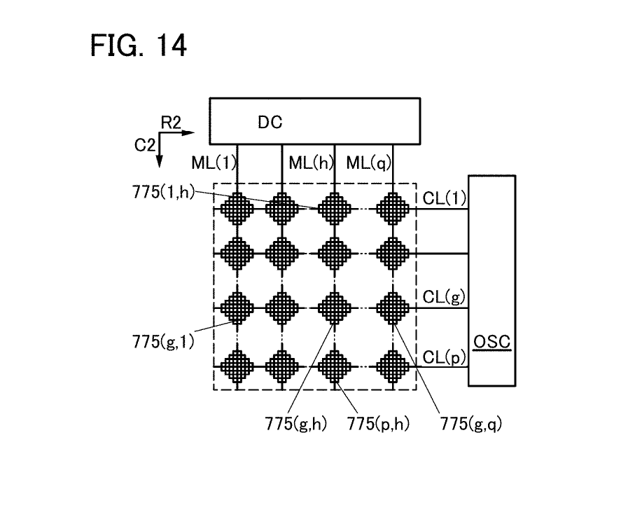

FIG. 14 is a block diagram illustrating a structure of the input portion that can be used in the input/output device of one embodiment of the present invention.

### Structure Example 1 of Input/Output Device

The input/output device described in this embodiment includes the display panel 700 of the display device described in Embodiment 1 and the input portion (see FIG. 11A, FIG. 12A, and FIG. 13). The input portion has a function of sensing an object that approaches a region overlapping with the display panel 700.

### <<Structure Example of Input Portion>>

The input portion of the display device described in this embodiment includes the region overlapping with the display panel 700 (see FIG. 11A, FIG. 12A, and FIG. 13).

The input portion includes a control line CL(g), a sensor signal line ML(h), and a sensing element 775(g,h) (see FIG. 11B).

The control line CL(g) has a function of supplying a control signal.

The sensor signal line ML(h) has a function of receiving a sensor signal.

The sensing element 775(g,h) is electrically connected to the control line CL(g) and the sensor signal line ML(h).

The sensing element 775(g,h) has a light-transmitting property. The sensing element 775(g,h) includes an electrode C(g) and an electrode M(h).

The electrode C(g) is electrically connected to the control line CL(g).

The electrode M(h) is electrically connected to the sensor signal line ML(h) and is provided so that an electric field part of which is blocked by an object that approaches the region overlapping with the display panel 700 is generated between the electrode M(h) and the electrode C(g).

The sensing element 775(g,h) has a function of supplying the sensor signal which changes in accordance with the control signal and a distance between the sensing element 775(g,h) and an object that approaches the region overlapping with the display panel 700.

Thus, the object that approaches the region overlapping with the display panel can be sensed while the image data is displayed on the display panel. As a result, a novel input/output device that is highly convenient or reliable can be provided.

The input portion described in this embodiment includes a group of sensing elements 775(g,1) to 775(g,q) and another group of sensing elements 775(1,h) to 775(p,h) (see FIG. 14). Note that g is an integer greater than or equal to 1 and less than or equal to p, h is an integer greater than or equal to 1 and less than or equal to q, and each of p and q is an integer greater than or equal to 1.

The group of sensing elements 775(g,1) to 775(g,q) include the sensing element 775(g,h) and are provided in the row direction (indicated by an arrow R2 in the drawing). Note that the direction indicated by the arrow R2 in FIG. 14 may be the same as or different from the direction indicated by the arrow R1 in FIG. 1A.

The other group of sensing elements 775(1,h) to 775(p,h) include the sensing element 775(g,h) and are provided in the column direction (the direction indicated by an arrow C2 in the drawing) that intersects the row direction.

The group of sensing elements 775(g,1) to 775(g,q) provided in the row direction include the electrode C(g) that is electrically connected to the control line CL(g).

The other group of sensing elements 775(1,h) to 775(p,h) provided in the column direction include the electrode M(h) that is electrically connected to the sensor signal line ML(h).

The control line CL(g) of the input/output panel described in this embodiment includes a conductive film BR(g,h) (see FIG. 12A). The conductive film BR(g,h) includes a region overlapping with the sensor signal line ML(h).

An insulating film 706 includes a region positioned between the sensor signal line ML(h) and the conductive film BR(g,h). Thus, a short circuit between the sensor signal line ML(h) and the conductive film BR(g,h) can be prevented.

The input/output panel described in this embodiment includes an oscillator circuit OSC and a detection circuit DC (see FIG. 14).

The oscillator circuit OSC is electrically connected to the control line CL(g) and has a function of supplying a control signal. For example, a rectangular wave, a sawtooth wave, a triangular wave, or the like can be used as the control signal.

The detection circuit DC is electrically connected to the sensor signal line ML(h) and has a function of supplying a sensor signal on the basis of a change in the potential of the sensor signal line ML(h).

An input/output device 700TP2 is different from the display device, which is described with reference to FIGS. 5A and 5B, FIGS. 6A and 6B, and FIGS. 7A and 7B, in that a top-gate transistor is included; a functional layer 720 including the input portion is included in a region surrounded by the substrate 770, the insulating film 501C, and the sealant 705; the electrode C(g) including an opening in a region overlapping with the pixel 702(i,j) is included; the electrode M(h) including an opening in a region overlapping with the pixel 702(i,j) is included; a conductive film 511D electrically connected to the control line CL(g) or the sensor signal line ML(h) is included; and a terminal 519D electrically connected to the conductive film 511D is included. Different structures are described in detail below, and the above description is referred to for the other similar structures.

The control line CL(g) is electrically connected to the electrode C(g) provided with an opening, and the sensing signal line ML(h) is electrically connected to the electrode M(h) provided with an opening. The openings include the regions overlapping with the pixel. An opening of a conductive film included in the control line CL(g) includes a region overlapping with the pixel 702(11), for example (see FIGS. 11B and 11C and FIG. 12A). Note that the input/output device 700TP2 further includes the light-blocking film BM between the sensing element 775(g,h) and the substrate 770 (see FIG. 12A). The light-blocking film BM includes an opening in a region overlapping with the first display element 750(i,j). Moreover, the light-blocking film BM includes a region overlapping with the sensing element 775(g,h).

In the input/output device described in this embodiment, the gap between the control line CL(g) and the second electrode 752 or between the sensor signal line ML(h) and the second electrode 752 is greater than or equal to 0.2 μm and less than or equal to 16 μm, preferably greater than or equal to 1 μm and less than or equal to 8 μm, and further preferably greater than or equal to 2.5 μm and less than or equal to 4 μm.

The input/output device described in this embodiment includes the first electrode provided with the opening in the region overlapping with the pixel and the second electrode provided with the opening in the region overlapping with the pixel. Accordingly, an object that approaches the region overlapping with the display panel can be sensed without disturbing display of the display panel. Furthermore, the thickness of the input/output device can be reduced. As a result, a novel input/output device that is highly convenient or reliable can be provided.

In the input/output device described in this embodiment, the functional layer 720 is provided in the region surrounded by the substrate 770, the insulating film 501C, and the sealant 705.

The input/output device described in this embodiment includes the conductive film 511D (see FIG. 13).

Note that a conductive material CP or the like can be provided between the control line CL(g) and the conductive film 511D to electrically connect the control line CL(g) and the conductive film 511D. Alternatively, the conductive material CP or the like can be provided between the sensor signal line ML(h) and the conductive film 511D to electrically connect the sensor signal line ML(h) and the conductive film 511D.

The input/output device described in this embodiment also includes the terminal 519D electrically connected to the conductive film 511D. The terminal 519D includes the conductive film 511D.

Note that for example, the terminal 519D can be electrically connected to a flexible printed circuit FPC2 using a conductive material ACF2. Accordingly, a control signal can be supplied to the control line CL(g) using the terminal 519D, or a sensor signal can be supplied from the sensor signal line ML(h) using the terminal 519D, for example.

### <<Conductive Film 511D>>

A material that can be used for the wiring or the like can be used for the conductive film 511D, for example.

### <<Terminal 519D>>

A material that can be used for the wiring or the like can be used for the terminal 519D, for example. Specifically, the terminal 519D can have the same structure as that of the terminal 519B or the terminal 519C. Note that the terminal 519D can be electrically connected to the flexible printed circuit FPC2 using the conductive material ACF2, for example (see FIG. 13).

### <<Switch SW1, Transistor M, Transistor MD>>

A transistor that can be used as the switch SW1, the transistor M, and the transistor MD each include the conductive film 504 having a region overlapping with the insulating film 501C and the semiconductor film 508 having a region positioned between the insulating film 501C and the conductive film 504. Note that the conductive film 504 functions as a gate electrode (see FIG. 12B).

The semiconductor film 508 includes a first region 508A, a second region 508B, and a third region 508C. The first region 508A and the second region 508B do not overlap with the conductive film 504. The third region 508C is positioned between the first region 508A and the second region 508B and overlaps with the conductive film 504.

The transistor MD includes the insulating film 506 between the third region 508C and the conductive film 504. Note that the insulating film 506 functions as a gate insulating film.

The first region 508A and the second region 508B have a lower resistivity than the third region 508C, and function as a source region and a drain region.

The first region 508A and the second region 508B can be formed in the semiconductor film 508 by, for example, performing plasma treatment on an oxide semiconductor film using a gas containing a rare gas.

The conductive film 504 can be used as a mask, for example. The use of the conductive film 504 as a mask allows the shape of part of the third region 508C to be self-aligned with the shape of an end portion of the conductive film 504.

The transistor MD includes the conductive film 512A and the conductive film 512B that are in contact with the first region 508A and the second region 508B, respectively. The conductive film 512A and the conductive film 512B function as a source electrode and a drain electrode.

A transistor that can be formed in the same process as the transistor MD can be used as the transistor M.

Note that this embodiment can be combined with any of the other embodiments in this specification as appropriate.

### Embodiment 3

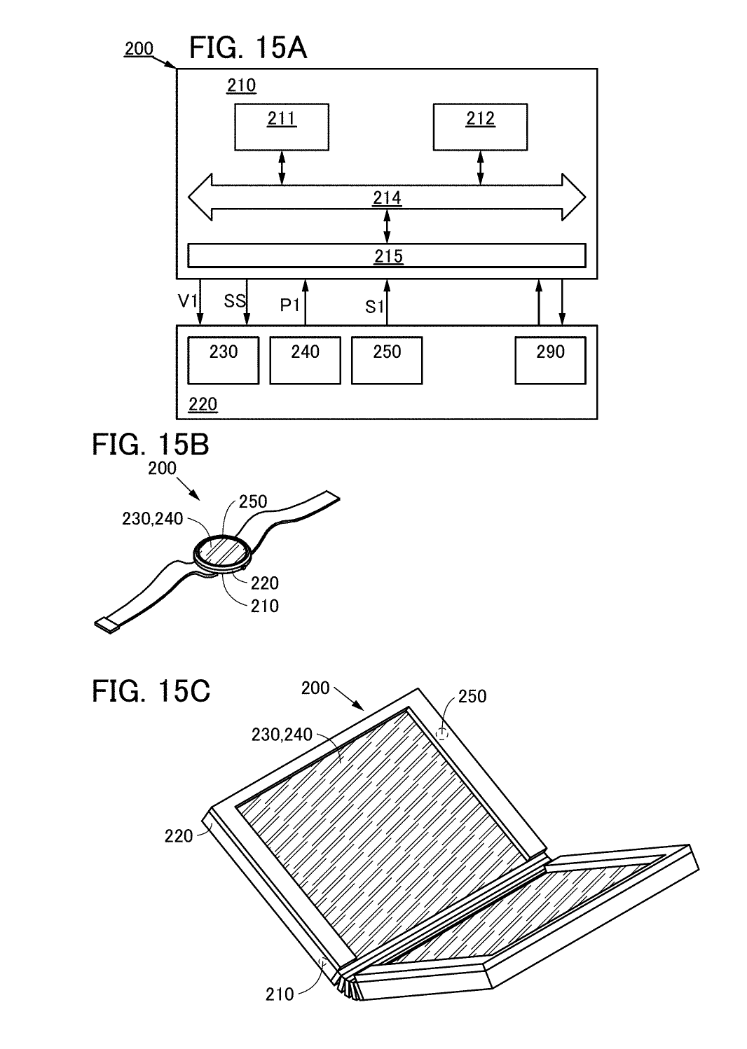

In this embodiment, a structure of a data processor of one embodiment of the present invention is described with reference to FIGS. 15A to 15C, FIGS. 16A and 16B, FIGS. 17A and 17B, FIG. 18, and FIG. 19.

FIG. 15A is a block diagram illustrating the structure of the data processor of one embodiment of the present invention. FIGS. 15B and 15C are projection views illustrating examples of external views of the data processor 200.

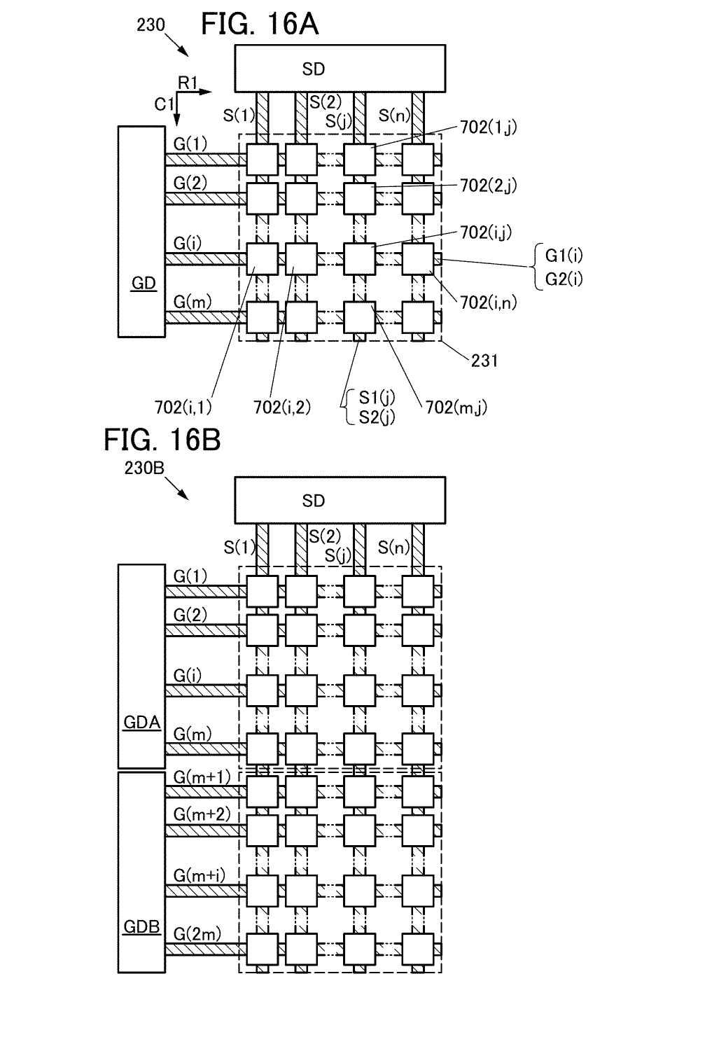

FIGS. 16A and 16B are block diagrams each illustrating a structure of a display portion of the data processor of one embodiment of the present invention. FIG. 16A is a block diagram illustrating the structure of the display portion of the data processor of one embodiment of the present invention, and FIG. 16B is a block diagram illustrating a structure different from that in FIG. 16A.

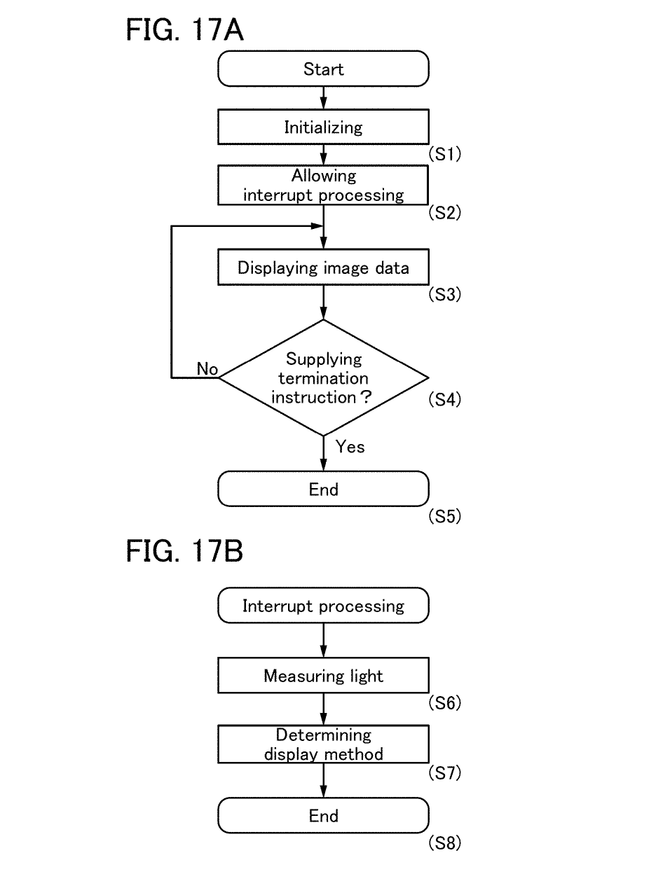

FIGS. 17A and 17B are flow charts showing the program of one embodiment of the present invention. FIG. 17A is a flow chart showing main processing of the program of one embodiment of the present invention, and FIG. 17B is a flow chart showing interrupt processing.

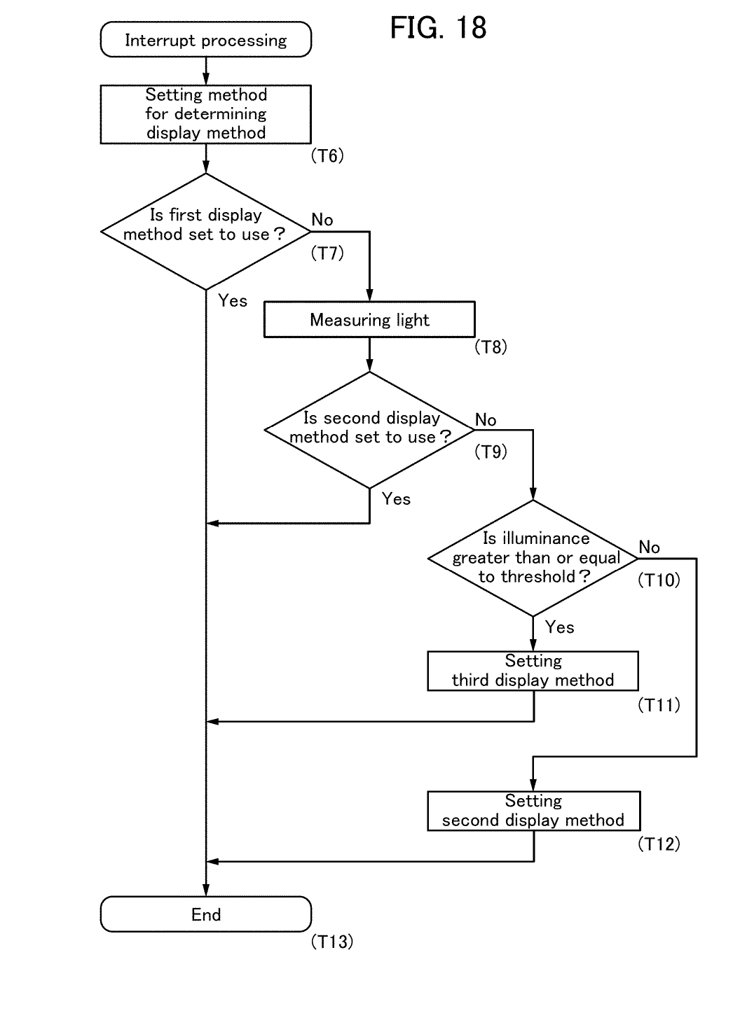

FIG. 18 is a flow chart showing interrupt processing of the program of one embodiment of the present invention.

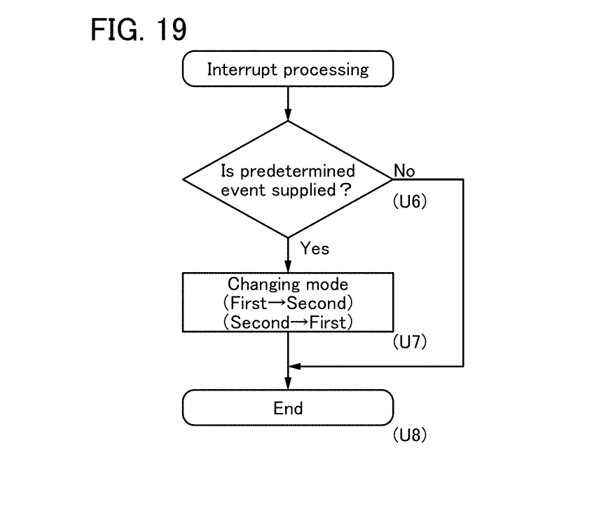

FIG. 19 is a flow chart showing interrupt processing of the program of one embodiment of the present invention.

### Structure Example 1 of Data Processor

A data processor 200 described in this embodiment includes an input/output device 220 and an arithmetic device 210 (see FIG. 15A). The input/output device 220 is electrically connected to the arithmetic device 210. The data processor 200 can include a housing (see FIG. 15B).

The input/output device 220 includes a display portion 230 and an input portion 240 (see FIG. 15A). The input/output device 220 also includes a sensor portion 250. The input/output device 220 can include a communication portion 290.

The input/output device 220 has a function of receiving the image data V1 or the control data SS and a function of supplying positional data P1 or sensing data S1.

The arithmetic device 210 has a function of receiving the positional data P1 or the sensing data S1 and a function of supplying the image data V1. The arithmetic device 210 has a function of operating on the basis of the positional data P1 or the sensing data S1, for example.

Note that the housing has a function of storing the input/output device 220 or the arithmetic device 210. Alternatively, the housing has a function of supporting the display portion 230 or the arithmetic device 210.

The display portion 230 has a function of displaying an image on the basis of the image data V1. The display portion 230 has a function of displaying an image on the basis of the control data SS.

The input portion 240 has a function of supplying the positional data P1.

The sensor portion 250 has a function of supplying the sensing data S1. The sensor portion 250 has a function of measuring the illuminance of an environment where the data processor 200 is used and a function of supplying illuminance data, for example. The sensor portion 250 has a function of measuring the chromaticity of ambient light in the environment where the data processor 200 is used and a function of supplying illuminance data, for example.

Thus, the data processor can identify the intensity of light received by the housing of the data processor and operate under a usage environment. As a result, a novel data processor that is highly convenient or reliable can be provided.

Individual components included in the data processor are described below. Note that these components cannot be clearly distinguished and one component may also serve as another component or include part of another component. For example, a touch panel in which a touch sensor is provided so as to overlap with a display panel serves as an input portion as well as a display portion.

### Structure Example

The data processor 200 of one embodiment of the present invention includes the housing, an attitude sensor, a photosensor, or the arithmetic device 210.

The arithmetic device 210 includes an arithmetic portion 211, a memory portion 212, a transmission path 214, or an input/output interface 215.

The data processor of one embodiment of the present invention includes the input/output device 220.

The input/output device 220 includes the display portion 230, the input portion 240, the sensor portion 250, and the communication portion 290.

The sensor portion 250 includes the attitude sensor and the photosensor.

### <<Data Processor>>

The data processor of one embodiment of the present invention includes the arithmetic device 210 or the input/output device 220.

### <<Arithmetic Device 210>>

The arithmetic device 210 includes the arithmetic portion 211 and the memory portion 212. The arithmetic device 210 further includes the transmission path 214 and the input/output interface 215.

### <<Arithmetic Portion 211>>

The arithmetic portion 211 has a function of, for example, executing a program.

### <<Memory Portion 212>>

The memory portion 212 has a function of, for example, storing the program executed by the arithmetic portion 211, initial data, setting data, an image, or the like.

Specifically, a hard disk, a flash memory, a memory including a transistor including an oxide semiconductor, or the like can be used for the memory portion 212.

### <<Input/Output Interface 215, Transmission Path 214>>

The input/output interface 215 includes a terminal or a wiring and has a function of supplying and receiving data. For example, the input/output interface 215 can be electrically connected to the transmission path 214 and the input/output device 220.

The transmission path 214 includes a wiring and has a function of supplying and receiving data. For example, the transmission path 214 can be electrically connected to the arithmetic portion 211, the memory portion 212, or the input/output interface 215.

### <<Input/Output Device 220>>

The input/output device 220 includes the display portion 230, the input portion 240, the sensor portion 250, or the communication portion 290. For example, the input/output device described in Embodiment 2 can be used. In that case, power consumption can be reduced.

### <<Display Portion 230>>

The display portion 230 includes the control portion 238, the driver circuit GD, the driver circuit SD, and the display panel 700 (see FIG. 1A).

The display panel 700 includes a display region 231 (see FIG. 16A). Note that the display panel 700 can include the driver circuit GD or the driver circuit SD.

### <<Control Portion 238>>

The correction circuit 235C described in Embodiment 1 can be used, for example.

### <<Display Region 231>>

The display region 231 includes a group of pixels 702(1,1) to 702(i,n), another group of pixels 702(1,j) to 702(m,j), the scan line G1 (i), and the scan line G2(i) (see FIG. 16A). Note that i is an integer greater than or equal to 1 and less than or equal to m, j is an integer greater than or equal to 1 and less than or equal to n, and each of m and n is an integer greater than or equal to 1.

The group of pixels 702(i,1) to 702(i,n) include the pixel 702(i,j) and are provided in the row direction (the direction indicated by the arrow R1 in the drawing).

The other group of pixels 702(1,j) to 702(m,j) include the pixel 702(i,j) and are provided in the column direction (the direction indicated by the arrow C1 in the drawing) that intersects the row direction.

The scan line G1 (i) and the scan line G2(i) are electrically connected to the group of pixels 702(i,1) to 702(i,n) provided in the row direction.

The signal line S1 (j) and the signal line S2(j) are electrically connected to the other group of pixels 702(1,j) to 702(m,j) provided in the column direction.

The display portion 230 can include a plurality of driver circuits. For example, a display portion 230B can include a driver circuit GDA and a driver circuit GDB (see FIG. 16B).

### <<Driver Circuit GD>>

The driver circuit GD has a function of supplying a selection signal on the basis of the control data.

For example, the driver circuit GD has a function of supplying a selection signal to one scan line at a frequency of 30 Hz or higher, preferably 60 Hz or higher, on the basis of the control data. Accordingly, moving images can be smoothly displayed.

For example, the driver circuit GD has a function of supplying a selection signal to one scan line at a frequency of lower than 30 Hz, preferably lower than 1 Hz, further preferably less than once per minute, on the basis of the control data. Accordingly, a still image can be displayed while flickering is suppressed.

For example, in the case where a plurality of driver circuits are provided, the driver circuits GDA and GDB may supply the selection signals at different frequencies. Specifically, the selection signal can be supplied at a higher frequency to a region on which moving images are smoothly displayed than to a region on which a still image is displayed in a state where flickering is suppressed.

### <<Driver Circuit SD, Driver Circuit SD1, Driver Circuit SD2>>

The driver circuit SD includes a driver circuit SD1 and a driver circuit SD2. The driver circuit SD1 has a function of supplying an image signal on the basis of the first gray level signal V11. The driver circuit SD2 has a function of supplying an image signal on the basis of the second gray level signal V12 (see FIG. 1A).

The driver circuit SD1 has a function of generating an image signal to be supplied to a pixel circuit electrically connected to a reflective display element, for example. Specifically, the driver circuit SD1 has a function of generating a signal whose polarity is inverted. Thus, for example, a reflective liquid crystal display element can be driven.

The driver circuit SD2 has a function of generating an image signal to be supplied to a pixel circuit electrically connected to a light-emitting element, for example.

For example, any of a variety of sequential circuits, such as a shift register, can be used as the driver circuit SD.

For example, an integrated circuit in which the driver circuit SD1 and the driver circuit SD2 are integrated can be used as the driver circuit SD. Specifically, an integrated circuit formed over a silicon substrate can be used as the driver circuit SD.

For example, the driver circuit SD can be mounted on a terminal by a chip on glass (COG) method. Specifically, an anisotropic conductive film can be used to mount an integrated circuit on the terminal. Alternatively, a chip on film (COF) method may be used to mount an integrated circuit on the terminal.

<<Pixel 702(i,j)>>

The pixel 702(i,j) includes the first display element 750(i,j), the second display element 550(i,j), and the pixel circuit 530(i,j). The pixel circuit 530(i,j) has a function of driving the first display element 750(i,j) and the second display element 550(i,j).

<<First Display Element 750(i,j)>>

A display element having a function of controlling transmission or reflection of light can be used as the first display element 750(i,j), for example. Specifically, a reflective liquid crystal display element can be used as the first display element 750(i,j). Alternatively, a MEMS shutter display element and the like can be used. The use of a reflective display element can reduce power consumption of a display panel.

<<Second Display Element 550(i,j)>>

A display element having a function of emitting light can be used as the second display element 550(i,j), for example. Specifically, an organic EL element and the like can be used.

### <<Pixel Circuit>>

A circuit having a function of driving the first display element 750(i,j) and the second display element 550(i,j) can be used as a pixel circuit.

A switch, a transistor, a diode, a resistor, an inductor, a capacitor, or the like can be used in the pixel circuit.

For example, one or a plurality of transistors can be used as a switch. Alternatively, a plurality of transistors connected in parallel, in series, or in combination of parallel connection and series connection can be used as a switch.

### <<Transistor>>

For transistors in the driver circuit and the pixel circuit, semiconductor films formed at the same step can be used, for example.

For example, bottom-gate transistors, top-gate transistors, or the like can be used.

A manufacturing line for a bottom-gate transistor including amorphous silicon as a semiconductor can be easily remodeled into a manufacturing line for a bottom-gate transistor including an oxide semiconductor as a semiconductor, for example. Furthermore, for example, a manufacturing line for a top-gate transistor including polysilicon as a semiconductor can be easily remodeled into a manufacturing line for a top-gate transistor including an oxide semiconductor as a semiconductor. In any reconstruction, a conventional manufacturing line can be effectively used.

For example, a transistor including a semiconductor containing an element belonging to Group 14 can be used. Specifically, a semiconductor containing silicon can be used for a semiconductor film. For example, single crystal silicon, polysilicon, microcrystalline silicon, or amorphous silicon can be used for the semiconductor film of the transistor.

Note that the temperature for forming a transistor using polysilicon in a semiconductor is lower than the temperature for forming a transistor using single crystal silicon in a semiconductor.

In addition, the transistor using polysilicon in a semiconductor has higher field-effect mobility than the transistor using amorphous silicon in a semiconductor, and therefore a pixel including the transistor using polysilicon can have a high aperture ratio. Moreover, pixels arranged at an extremely high density, a gate driver circuit, and a source driver circuit can be formed over the same substrate. As a result, the number of components included in an electronic device can be reduced.

In addition, the transistor using polysilicon in a semiconductor has higher reliability than the transistor using amorphous silicon in a semiconductor.

For example, a transistor including an oxide semiconductor can be used. Specifically, an oxide semiconductor containing indium or an oxide semiconductor containing indium, gallium, and zinc can be used for a semiconductor film.

For example, a transistor having a lower leakage current in an off state than a transistor that uses amorphous silicon in a semiconductor film can be used. Specifically, a transistor that uses an oxide semiconductor in a semiconductor film can be used.

In that case, the pixel circuit can hold an image signal for a longer time than a pixel circuit including a transistor that uses amorphous silicon in a semiconductor film. Specifically, the selection signal can be supplied at a frequency of lower than 30 Hz, preferably lower than 1 Hz, further preferably less than once per minute while flickering is suppressed. Consequently, eyestrain on a user of the data processor can be reduced, and power consumption for driving can be reduced.

Alternatively, for example, a transistor including a compound semiconductor can be used. Specifically, a semiconductor containing gallium arsenide can be used for a semiconductor film.

For example, a transistor including an organic semiconductor can be used. Specifically, an organic semiconductor containing any of polyacenes and graphene can be used for the semiconductor film.

### <<Input Portion 240>>

Any of a variety of human interfaces or the like can be used as the input portion 240 (see FIG. 15A).

For example, a keyboard, a mouse, a touch sensor, a microphone, a camera, or the like can be used as the input portion 240. Note that a touch sensor having a region overlapping with the display portion 230 can be used. An input/output device that includes the display portion 230 and a touch sensor having a region overlapping with the display portion 230 can be referred to as a touch panel or a touch screen.

For example, a user can make various gestures (e.g., tap, drag, swipe, and pinch in) using his/her finger as a pointer on the touch panel.

The arithmetic device 210, for example, analyzes data on the position, track, or the like of the finger on the touch panel and determines that a specific gesture is supplied when the analysis results meet predetermined conditions. Therefore, the user can supply a predetermined operation instruction associated with a predetermined gesture by using the gesture.

For instance, the user can supply a “scrolling instruction” for changing a portion where image data is displayed by using a gesture of touching and moving his/her finger on the touch panel.

### <<Sensor Portion 250>>

The sensor portion 250 has a function of sensing the surroundings and supplying the sensing data such as illuminance data, attitude data, pressure data, and positional data.

For example, a photosensor, an attitude sensor, an acceleration sensor, a direction sensor, a global positioning system (GPS) signal receiving circuit, a pressure sensor, a temperature sensor, a humidity sensor, a camera, or the like can be used as the sensor portion 250.

### <<Communication Portion 290>>

The communication portion 290 has a function of supplying and acquiring data to/from a network.

### <<Program>>

The program of one embodiment of the present invention has the following steps (see FIG. 17A).

### [First Step]

In the first step, setting is initialized (see (S1) in FIG. 17A).

For example, predetermined image data that is to be displayed on starting and data for identifying a predetermined mode of displaying the image data and a predetermined method of displaying the image data are acquired from the memory portion 212. Specifically, a still image data or another moving image data can be used as the predetermined image data. Furthermore, a first mode or a second mode can be used as the predetermined mode. Furthermore, a first display method, a second display method, or a third display method can be used as the predetermined display method.

### [Second Step]

In the second step, interrupt processing is allowed (see (S2) in FIG. 17A). Note that an arithmetic device allowed to execute the interrupt processing can perform the interrupt processing in parallel with the main processing. The arithmetic device that has returned from the interrupt processing to the main processing can reflect the results of the interrupt processing in the main processing.

The arithmetic device may execute the interrupt processing when a counter has an initial value, and the counter may be set at a value other than the initial value when the arithmetic device returns from the interrupt processing. Thus, the interrupt processing is ready to be executed after the program is started up.

### [Third Step]

In the third step, image data is displayed in the predetermined mode or the predetermined display method selected in the first step or the interrupt processing (see (S3) in FIG. 17A). Note that the predetermined mode identifies a mode for displaying the image data, and the predetermined display method identifies a method for displaying the image data.

For example, a method for displaying the image data V1 can be associated with the first mode. Furthermore, another method for displaying the image data V1 can be associated with the second mode. Thus, a display method can be selected on the basis of the selected mode.

For example, three different methods for displaying the image data V1 can be associated with the first to third display methods. Thus, display can be performed on the basis of the selected display method.

### <<First Mode>>

Specifically, a method of supplying selection signals to a scan line at a frequency of 30 Hz or more, preferably 60 Hz or more, and performing display in accordance with the selection signals can be associated with the first mode.

For example, the supply of selection signals at a frequency of 30 Hz or more, preferably 60 Hz or more, can display a smooth moving image.

For example, an image is refreshed at a frequency of 30 Hz or more, preferably 60 Hz or more, so that an image smoothly following the user's operation can be displayed on the data processor 200 operated by the user.

### <<Second Mode>>

Specifically, a method of supplying selection signals to a scan line at a frequency of less than 30 Hz, preferably less than 1 Hz, further preferably once a minute and performing display in accordance with the selection signals can be associated with the second mode.

The supply of selection signals at a frequency of less than 30 Hz, preferably less than 1 Hz, further preferably once a minute, can perform display with flickers reduced. Furthermore, power consumption can be reduced.

For example, when the data processor 200 is used for a clock or watch, the display can be refreshed at a frequency of once a second, once a minute, or the like.

For example, when a light-emitting element is used as the second display element, the light-emitting element can be configured to emit light in a pulsed manner so as to display image data. Specifically, an organic EL element can be configured to emit light in a pulsed manner, and its afterglow can be used for display. The organic EL element has excellent frequency characteristics; thus, time for driving the light-emitting element can be shortened, and thus power consumption can be reduced in some cases. Alternatively, heat generation can be inhibited, and thus the deterioration of the light-emitting element can be suppressed in some cases.

### <<First Display Method>>

Specifically, a method in which the first display element 750(i,j) is used to display image data can be used as the first display method. Thus, for example, the power consumption can be reduced. Furthermore, image data with high contrast can be favorably displayed in a bright environment.

### <<Second Display Method>>

Specifically, a method in which the second display element 550(i,j) is used to display image data can be used as the second display method. Thus, for example, an image can be favorably displayed in a dark environment. Furthermore, a photograph and the like can be displayed with favorable color reproducibility. Furthermore, a moving image which moves quickly can be displayed smoothly.

Note that when the image data V1 is displayed using the second display element 550(i,j), the brightness of the image data V1 can be determined on the basis of the illuminance data. For example, when illuminance is higher than or equal to 1000 lux and less than 100,000 lux, the image data V1 is displayed using the second display element 550(i,j) to be brighter than the case where the illuminance is less than 1000 lux.

### <<Third Display Method>>

Specifically, a method in which the first display element 750(i,j) and the second display element 550(i,j) are used to display image data can be used as the third display method. Thus, power consumption can be reduced, for example. Furthermore, an image can be favorably displayed in a dark environment. Furthermore, a photograph and the like can be displayed with favorable color reproducibility. Furthermore, a moving image which moves quickly can be displayed smoothly.

Note that a function of adjusting the brightness of display while performing display with the first display element 750(i,j) and the second display element 550(i,j) can be referred to as a light adjusting function. For example, the brightness of a reflective display element can be compensated using a light-emitting display element.

Furthermore, a function of adjusting the color of display while performing display with the first display element 750(i,j) and the second display element 550(i,j) can be referred to as a color adjusting function. For example, the color of a reflective display element can be changed using a light-emitting display element. Specifically, a yellowish color displayed by a reflective liquid crystal element can be made closer to a white color with the use of a blue organic EL element. Thus, text data can be displayed as texts printed on plain paper, for example. Furthermore, an eye-friendly display can be achieved.

### [Fourth Step]

In a fourth step, the processing proceeds to a fifth step when a termination instruction is supplied, and the processing proceeds to the third step when the termination instruction is not supplied (see (S4) in FIG. 17A).

For example, the termination instruction supplied in the interrupt processing can be used to determine the next step.

### [Fifth Step]

In the fifth step, the program terminates (see (S5) in FIG. 17A).

### <<Interrupt Processing>>

The interrupt processing includes sixth to eighth steps described below (see FIG. 17B).

### [Sixth Step]

In the sixth step, the illuminance of the environment where the data processor 200 is used is measured using the sensor portion 250, for example (see (S6) in FIG. 17B). Note that the color temperature or chromaticity of ambient light can be measured instead of the illuminance of the environment.

### [Seventh Step]

In the seventh step, a display method is determined on the basis of the measured illuminance data. For example, the first display method is selected when the illuminance is greater than or equal to the predetermined value, whereas the second display method is selected when the illuminance is less than the predetermined value. The third display method may be selected when the illuminance is in a predetermined range (see (S7) in FIG. 17B).

Specifically, the first display method may be selected when the illuminance is greater than or equal to 100,000 lux, the second display method may be selected when the illuminance is less than 5000 lux, and the third display method may be selected when the illuminance is greater than or equal to 5000 lux and less than 100,000 lux.

Note that when the color temperature or chromaticity of the ambient light is measured in the sixth step, the color of display may be adjusted by the third display method using the second display element 550(i,j).

For example, the first-status control data SS is supplied when the first display method is used, the second-status control data SS is supplied when the second display method is used, and the third-status control data SS is supplied when the third display method is used.

### [Eighth Step]

In the eighth step, the interrupt processing terminates (see (S8) in FIG. 17B).

### Structure Example 2 of Data Processor

Another structure of the data processor of one embodiment of the present invention is described with reference to FIG. 18.

FIG. 18 is a flow chart showing the program of one embodiment of the present invention. The interrupt processing in the flow chart in FIG. 18 is different from that in FIG. 17B.

Note that the structure example 2 of the data processor is different from the interrupt processing in FIG. 17B in that the interrupt processing includes a step of determining a display method on the basis of a display method which is manually set. Different structures are described in detail below, and the above description is referred to for the other similar structures.

### <<Interrupt Processing>>

The interrupt processing includes sixth to thirteenth steps described below (see FIG. 18).

### [Sixth Step]

In the sixth step, a method for determining the display method is set. For example, a method for determining the display method manually or automatically can be set (see (T6) in FIG. 18).

Specifically, the display method can be manually set to any of the first to third display methods. Alternatively, the second display method or the third display method can be automatically set on the basis of the measured illuminance data.

For example, the method for determining the display method may be set using a predetermined event associated with an instruction for setting the method for determining the display method.

### [Seventh Step]

In the seventh step, when the first display method is manually set to use, the first display method is selected as the display method and the processing proceeds to the thirteenth step. Furthermore, when the first display method is not set to use, the processing proceeds to the eighth step (see (T7) in FIG. 18).

Specifically, when the second display method is manually set to use or the display method is set so as to be determined automatically, the processing proceeds to the eighth step.

### [Eighth Step]

In the eighth step, the illuminance of the environment where the data processor 200 is used is measured using the sensor portion 250, for example (see (T8) in FIG. 18). Note that the color temperature or chromaticity of the ambient light can be measured instead of the illuminance of the environment.

### [Ninth Step]

In the ninth step, when the second display method is manually set to use, the second display method is selected as the display method and the processing proceeds to the thirteenth step. Furthermore, when the second display method is not set to use, that is, the display method is set so as to be determined automatically, the processing proceeds to the tenth step (see (T9) in FIG. 18).

Note that the brightness of display performed using the second display method can be determined on the basis of the illuminance of the environment measured in the eighth step.

### [Tenth Step]

In the tenth step, the display method is automatically determined on the basis of the measured illuminance data. For example, when the illuminance is greater than or equal to the predetermined value, the third display method is selected as the display method and the processing proceeds to the eleventh step. Furthermore, when the illuminance is less than the predetermined value, the second display method is selected as the display method and the processing proceeds to the twelfth step.

Specifically, the third display method may be selected when the illuminance is greater than or equal to 5000 lux, and the second display method may be selected when the illuminance is less than 5000 lux (see (T10) in FIG. 18).

### [Eleventh Step]

In the eleventh step, the display method is set to the third display method and the processing proceeds to the thirteenth step (see (T11) in FIG. 18).

### [Twelfth Step]

In the twelfth step, the display method is set to the second display method and the processing proceeds to the thirteenth step (see (T12) in FIG. 18).

### [Thirteenth Step]

In the thirteenth step, the interrupt processing terminates (see (T13) in FIG. 18).

### <<Predetermined Event>>

For example, the following events can be used: events supplied using a pointing device such as a mouse (e.g., “click” and “drag”) and events supplied to a touch panel with a finger or the like used as a pointer (e.g., “tap”, “drag”, and “swipe”).

Furthermore, for example, the position of a slide bar pointed by a pointer, the swipe speed, and the drag speed can be used for parameters assigned to an instruction associated with the predetermined event.

For example, data sensed by the sensor portion 250 is compared to a predetermined threshold, and the compared results can be used for the event.

Specifically, a pressure sensor or the like in contact with a button or the like that can be pushed in a housing can be used as the sensor portion 250.

<<Instruction Associated with Predetermined Event>>

The termination instruction can be associated with a predetermined event, for example.

For example, “page-turning instruction” for switching displayed image data from one to another can be associated with a predetermined event. Note that a parameter for determining the page-turning speed or the like when the “page-turning instruction” is executed can be supplied using the predetermined event.

For example, “scroll instruction” for moving the display position of part of image data and displaying another part continuing from that part can be associated with a predetermined event. Note that a parameter for determining the moving speed of the display position or the like when the “scroll instruction” is executed can be supplied using the predetermined event.

For example, an instruction for generating image data can be associated with a predetermined event. Note that the ambient luminance sensed by the sensor portion 250 may be used for a parameter for determining the brightness of a generated image.

### Structure Example 3 of Data Processor

Another structure of the data processor of one embodiment of the present invention is described with reference to FIG. 19.

FIG. 19 is a flow chart showing the program of one embodiment of the present invention. The interrupt processing in the flow chart in FIG. 19 is different from that in FIG. 17B.

Note that the structure example 3 of the data processor is different from the interrupt processing in FIG. 17B in that the interrupt processing includes a step of changing a mode on the basis of a supplied predetermined event. Different structures are described in detail below, and the above description is referred to for the other similar structures.

### <<Interrupt Processing>>

The interrupt processing includes sixth to eighth steps described below (see FIG. 19).

### [Sixth Step]

In the sixth step, the processing proceeds to the seventh step when a predetermined event is supplied, whereas the processing proceeds to the eighth step when the predetermined event is not supplied (see (U6) in FIG. 19). For example, whether the predetermined event is supplied in a predetermined period or not can be a branch condition. Specifically, the predetermined period can be longer than 0 seconds and shorter than or equal to 5 seconds, preferably shorter than or equal to 1 second, further preferably shorter than or equal to 0.5 seconds, still further preferably shorter than or equal to 0.1 seconds.

### [Seventh Step]

In the seventh step, the mode is changed (see (U7) in FIG. 19). Specifically, the mode is changed to the second mode when the first mode has been selected, or the mode is changed to the first mode when the second mode has been selected.

### [Eighth Step]

In the eighth step, the interrupt processing terminates (see (U8) in FIG. 19). Note that in a period in which the main processing is executed, the interrupt processing may be repeatedly executed.

Note that this embodiment can be combined with any of the other embodiments in this specification as appropriate.

### Embodiment 4

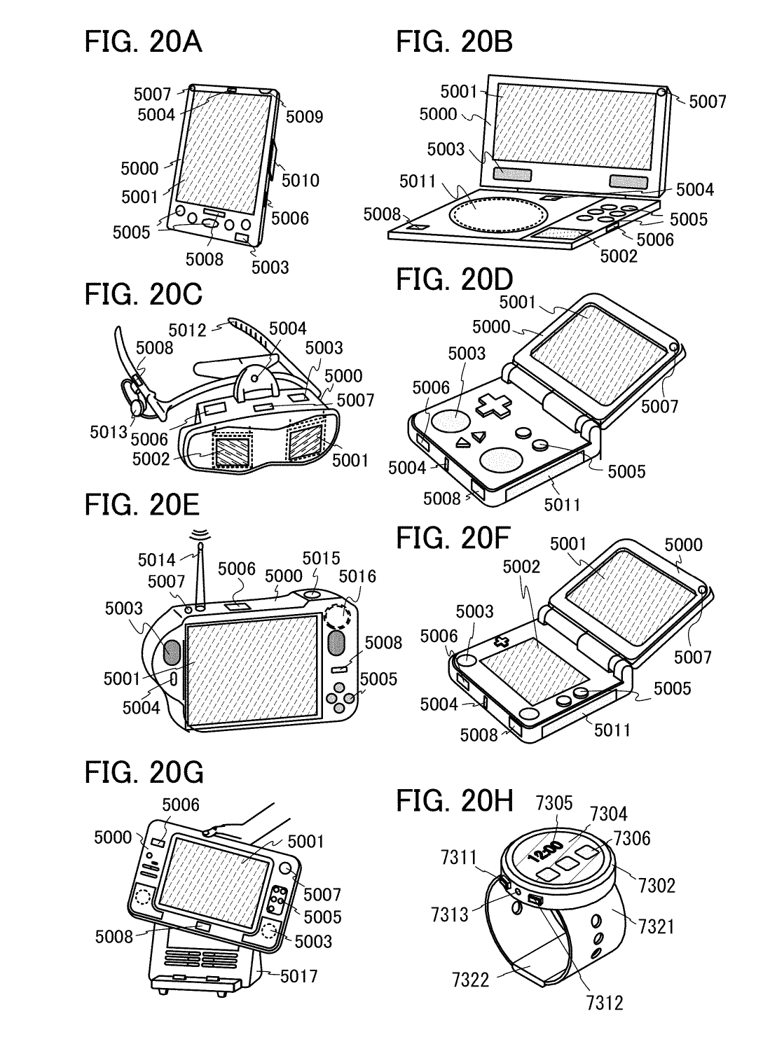

In this embodiment, electronic devices each of which includes the data processor of one embodiment of the present invention are described with reference to FIGS. 20A to 20H.

FIGS. 20A to 20G illustrate electronic devices. These electronic devices can include a housing 5000, a display portion 5001, a speaker 5003, an LED lamp 5004, operation keys 5005 (including a power switch or an operation switch), a connection terminal 5006, a sensor 5007 (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared ray), a microphone 5008, and the like.

FIG. 20A illustrates a mobile computer that can include a switch 5009, an infrared port 5010, and the like in addition to the above components. FIG. 20B illustrates a portable image reproducing device (e.g., a DVD reproducing device) provided with a recording medium, and the portable image reproducing device can include a second display portion 5002, a recording medium reading portion 5011, and the like in addition to the above components. FIG. 20C illustrates a goggle-type display that can include the second display portion 5002, a support portion 5012, an earphone 5013, and the like in addition to the above components. FIG. 20D illustrates a portable game console that can include the recording medium reading portion 5011 and the like in addition to the above components. FIG. 20E illustrates a digital camera with a television reception function, and the digital camera can include an antenna 5014, a shutter button 5015, an image receiving portion 5016, and the like in addition to the above components. FIG. 20F illustrates a portable game console that can include the second display portion 5002, the recording medium reading portion 5011, and the like in addition to the above components. FIG. 20G illustrates a portable television receiver that can include a charger 5017 capable of transmitting and receiving signals, and the like in addition to the above components.

The electronic devices illustrated in FIGS. 20A to 20G can have a variety of functions such as a function of displaying a variety of data (e.g., a still image, a moving image, and a text image) on the display portion, a touch panel function, a function of displaying a calendar, date, time, and the like, a function of controlling processing with a variety of software (programs), a wireless communication function, a function of being connected to a variety of computer networks with a wireless communication function, a function of transmitting and receiving a variety of data with a wireless communication function, and a function of reading out a program or data stored in a recording medium and displaying it on the display portion. Furthermore, the electronic device including a plurality of display portions can have a function of displaying image data mainly on one display portion while displaying text data on another display portion, a function of displaying a three-dimensional image by displaying images on a plurality of display portions with a parallax taken into account, or the like. Furthermore, the electronic device including an image receiving portion can have a function of shooting a still image, a function of taking moving images, a function of automatically or manually correcting a shot image, a function of storing a shot image in a recording medium (an external recording medium or a recording medium incorporated in the camera), a function of displaying a shot image on the display portion, or the like. Note that functions of the electronic devices illustrated in FIGS. 20A to 20G are not limited thereto, and the electronic devices can have a variety of functions.

FIG. 20H illustrates a smart watch, which includes a housing 7302, a display panel 7304, operation buttons 7311 and 7312, a connection terminal 7313, a band 7321, a clasp 7322, and the like.

The display panel 7304 mounted in the housing 7302 serving as a bezel includes a non-rectangular display region. The display panel 7304 may have a rectangular display region. The display panel 7304 can display an icon 7305 indicating time, another icon 7306, and the like.

The smart watch in FIG. 20H can have a variety of functions such as a function of displaying a variety of data (e.g., a still image, a moving image, and a text image) on the display portion, a touch panel function, a function of displaying a calendar, date, time, and the like, a function of controlling processing with a variety of software (programs), a wireless communication function, a function of being connected to a variety of computer networks with a wireless communication function, a function of transmitting and receiving a variety of data with a wireless communication function, and a function of reading out a program or data stored in a recording medium and displaying it on the display portion.

The housing 7302 can include a speaker, a sensor (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays), a microphone, and the like. Note that the smart watch can be manufactured using the light-emitting element for the display panel 7304.

Note that this embodiment can be combined with any of the other embodiments in this specification as appropriate.

For example, in this specification and the like, an explicit description “X and Y are connected” means that X and Y are electrically connected, X and Y are functionally connected, and X and Y are directly connected. Accordingly, without being limited to a predetermined connection relationship, for example, a connection relationship shown in drawings or texts, another connection relationship is included in the drawings or the texts.

Here, X and Y each denote an object (e.g., a device, an element, a circuit, a wiring, an electrode, a terminal, a conductive film, or a layer).

Examples of the case where X and Y are directly connected include the case where an element that allows an electrical connection between X and Y (e.g., a switch, a transistor, a capacitor, an inductor, a resistor, a diode, a display element, a light-emitting element, and a load) is not connected between X and Y, and the case where X and Y are connected without the element that allows the electrical connection between X and Y provided therebetween.

For example, in the case where X and Y are electrically connected, one or more elements that enable an electrical connection between X and Y (e.g., a switch, a transistor, a capacitor, an inductor, a resistor, a diode, a display element, a light-emitting element, and a load) can be connected between X and Y. Note that the switch is controlled to be turned on or off. That is, the switch is conducting or not conducting (is turned on or off) to determine whether current flows therethrough or not. Alternatively, the switch has a function of selecting and changing a current path. Note that the case where X and Y are electrically connected includes the case where X and Y are directly connected.

For example, in the case where X and Y are functionally connected, one or more circuits that enable a functional connection between X and Y (e.g., a logic circuit such as an inverter, a NAND circuit, or a NOR circuit; a signal converter circuit such as a D/A converter circuit, an A/D converter circuit, or a gamma correction circuit; a potential level converter circuit such as a power supply circuit (e.g., a step-up circuit or a step-down circuit) or a level shifter circuit for changing the potential level of a signal; a voltage source; a current source; a switching circuit; an amplifier circuit such as a circuit that can increase signal amplitude, the amount of current, or the like, an operational amplifier, a differential amplifier circuit, a source follower circuit, and a buffer circuit; a signal generation circuit; a memory circuit; or a control circuit) can be connected between X and Y. For example, even when another circuit is interposed between X and Y, X and Y are functionally connected if a signal output from X is transmitted to Y. Note that the case where X and Y are functionally connected includes the case where X and Y are directly connected and the case where X and Y are electrically connected.

Note that in this specification and the like, an explicit description “X and Y are electrically connected” means that X and Y are electrically connected (i.e., the case where X and Y are connected with another element or another circuit provided therebetween), X and Y are functionally connected (i.e., the case where X and Y are functionally connected with another circuit provided therebetween), and X and Y are directly connected (i.e., the case where X and Y are connected without another element or another circuit provided therebetween). That is, in this specification and the like, the explicit description “X and Y are electrically connected” is the same as the description “X and Y are connected”.

For example, any of the following expressions can be used for the case where a source (or a first terminal or the like) of a transistor is electrically connected to X through (or not through) Z1 and a drain (or a second terminal or the like) of the transistor is electrically connected to Y through (or not through) Z2, or the case where a source (or a first terminal or the like) of a transistor is directly connected to one part of Z1 and another part of Z1 is directly connected to X while a drain (or a second terminal or the like) of the transistor is directly connected to one part of Z2 and another part of Z2 is directly connected to Y.

Examples of the expressions include, “X, Y, a source (or a first terminal or the like) of a transistor, and a drain (or a second terminal or the like) of the transistor are electrically connected to each other, and X, the source (or the first terminal or the like) of the transistor, the drain (or the second terminal or the like) of the transistor, and Y are electrically connected to each other in this order”, “a source (or a first terminal or the like) of a transistor is electrically connected to X, a drain (or a second terminal or the like) of the transistor is electrically connected to Y, and X, the source (or the first terminal or the like) of the transistor, the drain (or the second terminal or the like) of the transistor, and Y are electrically connected to each other in this order”, and “X is electrically connected to Y through a source (or a first terminal or the like) and a drain (or a second terminal or the like) of a transistor, and X, the source (or the first terminal or the like) of the transistor, the drain (or the second terminal or the like) of the transistor, and Y are provided to be connected in this order”. When the connection order in a circuit configuration is defined by an expression similar to the above examples, a source (or a first terminal or the like) and a drain (or a second terminal or the like) of a transistor can be distinguished from each other to specify the technical scope.

Other examples of the expressions include, “a source (or a first terminal or the like) of a transistor is electrically connected to X through at least a first connection path, the first connection path does not include a second connection path, the second connection path is a path between the source (or the first terminal or the like) of the transistor and a drain (or a second terminal or the like) of the transistor, Z1 is on the first connection path, the drain (or the second terminal or the like) of the transistor is electrically connected to Y through at least a third connection path, the third connection path does not include the second connection path, and Z2 is on the third connection path” and “a source (or a first terminal or the like) of a transistor is electrically connected to X at least with a first connection path through Z1, the first connection path does not include a second connection path, the second connection path includes a connection path through which the transistor is provided, a drain (or a second terminal or the like) of the transistor is electrically connected to Y at least with a third connection path through Z2, and the third connection path does not include the second connection path”. Still another example of the expression is “a source (or a first terminal or the like) of a transistor is electrically connected to X through at least Z1 on a first electrical path, the first electrical path does not include a second electrical path, the second electrical path is an electrical path from the source (or the first terminal or the like) of the transistor to a drain (or a second terminal or the like) of the transistor, the drain (or the second terminal or the like) of the transistor is electrically connected to Y through at least Z2 on a third electrical path, the third electrical path does not include a fourth electrical path, and the fourth electrical path is an electrical path from the drain (or the second terminal or the like) of the transistor to the source (or the first terminal or the like) of the transistor”. When the connection path in a circuit configuration is defined by an expression similar to the above examples, a source (or a first terminal or the like) and a drain (or a second terminal or the like) of a transistor can be distinguished from each other to specify the technical scope.

Note that these expressions are examples and there is no limitation on the expressions. Here, X, Y, Z1, and Z2 each denote an object (e.g., a device, an element, a circuit, a wiring, an electrode, a terminal, a conductive film, and a layer).

Even when independent components are electrically connected to each other in a circuit diagram, one component has functions of a plurality of components in some cases. For example, when part of a wiring also functions as an electrode, one conductive film functions as the wiring and the electrode. Thus, “electrical connection” in this specification includes in its category such a case where one conductive film has functions of a plurality of components.

### Example

In this example, a structure and evaluation results of a display device of one embodiment of the present invention are described with reference to FIGS. 21A, 21B-1, 21B-2, 21B-3 and 21B-4 and FIGS. 22A and 22B.

FIGS. 21A, 21B-1, 21B-2, 21B-3, and 21B-4 are photographs showing a method for evaluating the fabricated display device.

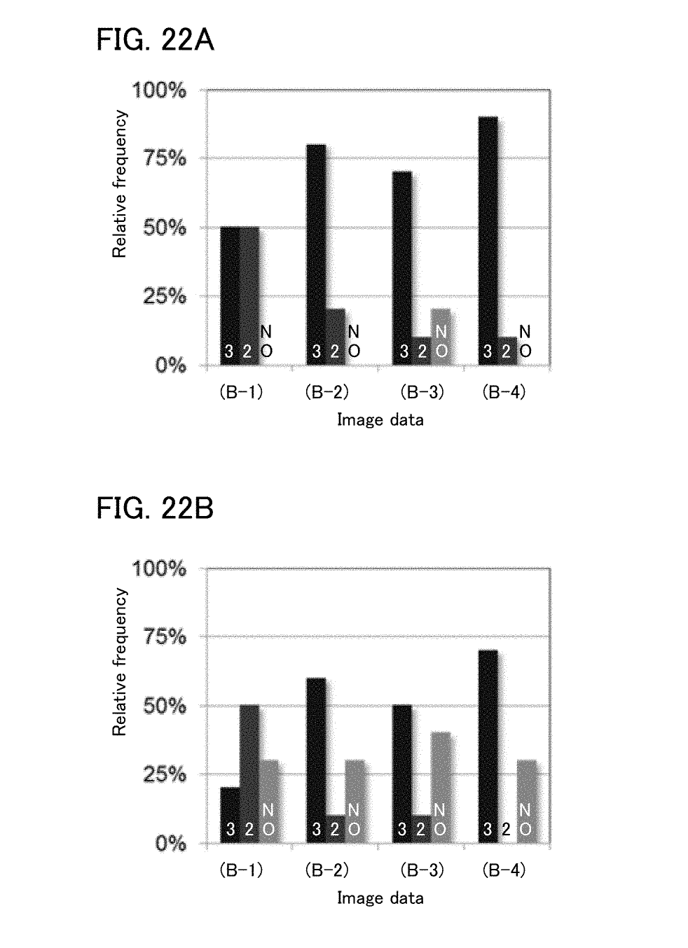

FIGS. 22A and 22B each show results of a sensory evaluation performed in this example. FIGS. 22A and 22B each show the results of the sensory evaluation where the illuminance of an environment is set to 1050 lux.

### Structure Example 1

The display device described in Embodiment 1 was fabricated. Table 1 shows the specifications of the fabricated display device.

TABLE 1

| | Specifications |
|---|---|
| Display Region | 4.38 inch |
| Driving Method | Active Matrix Method |
| Effective Pixels | 768 × RGB × 1024 |
| Pixel Size | 29 μm × RGB × 87 μm |
| Definition | 292 ppi |
| Aperture Ratio | 76% (Reflective Liquid Crystal Element) |
| | 3.9% (Organic EL Element) |
| Pixel Arrangement | RGB Stripe Arrangement |
| Source Driver | COF Method |
| Gate Driver | Built-in |

### <<Sensory Evaluation Method>>

A sensory evaluation for comparing display using the second display method and display using the third display method was performed.

Specifically, four still images each displayed using the two display methods were shown to 10 examinees, and they were asked in which display they felt higher quality and definition (see FIGS. 21B-1 to 21B-4).

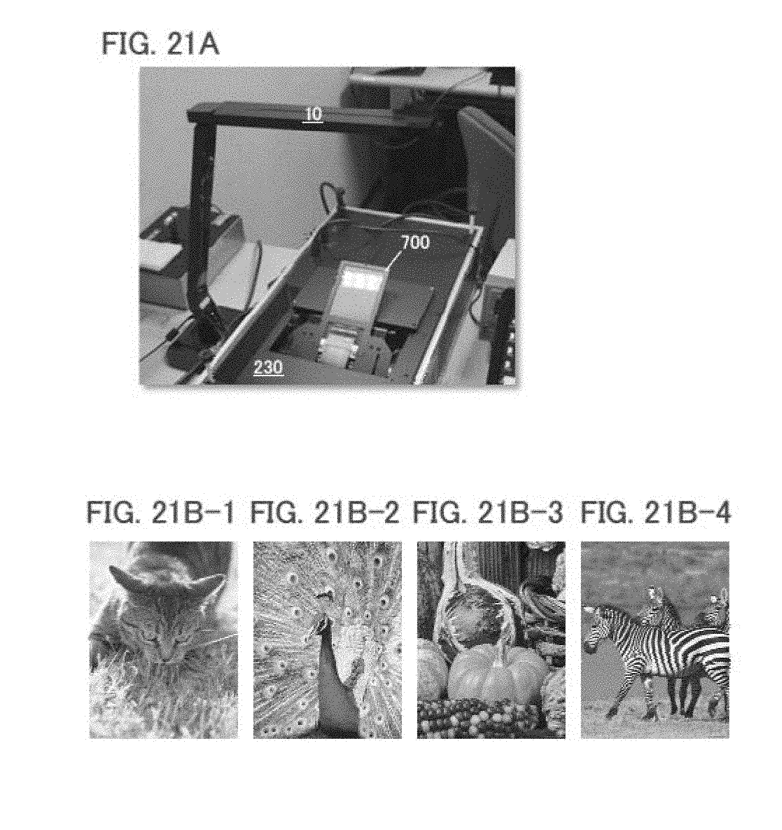

The illuminance of the environment was set to 1050 lux using interior light and a desk lamp 10 (see FIG. 21A). Note that the luminance displayed by the first display element was 20 cd/m² and the luminance displayed by the second display element was 150 cd/m².

In the sensory evaluation, the examinees were not told which of the two methods was used to perform display.

### <<Sensory Evaluation Result>>

FIG. 22A shows the results of the sensory evaluation where the examinees were asked in which display they felt higher quality. Note that reference numerals B-1 to B-4 in FIG. 22A correspond to the image data displayed on the display device, specifically, still images shown in FIGS. 21B-1 to 21B-4. A histogram with reference numeral 3 in the drawing corresponds to the number of examinees who felt higher quality in the display using the third display method. A histogram with reference numeral 2 in the drawing corresponds to the number of examinees who felt higher quality in the display using the second display method. A histogram with NO in the drawing corresponds to the number of examinees who had no opinion.

A large number of examinees felt higher quality in the display using the third display method than in the display using the second display method except when the image B-1 was displayed.

FIG. 22B shows the results of the sensory evaluation where the examinees were asked in which display they felt higher definition. A large number of examinees felt higher definition in the display using the third display method than in the display using the second display method except when the image B-1 was displayed.

### Comparative Example 1

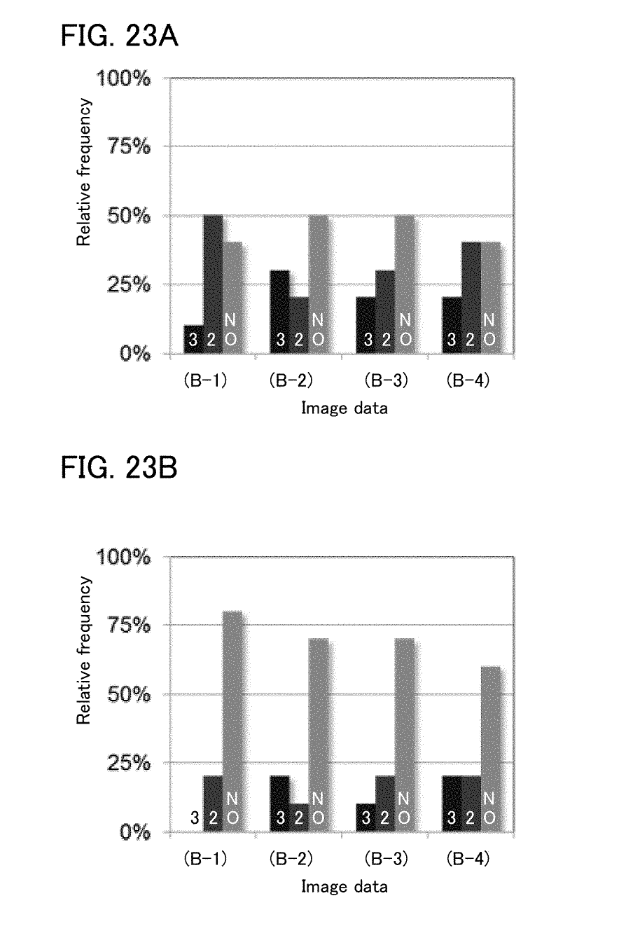

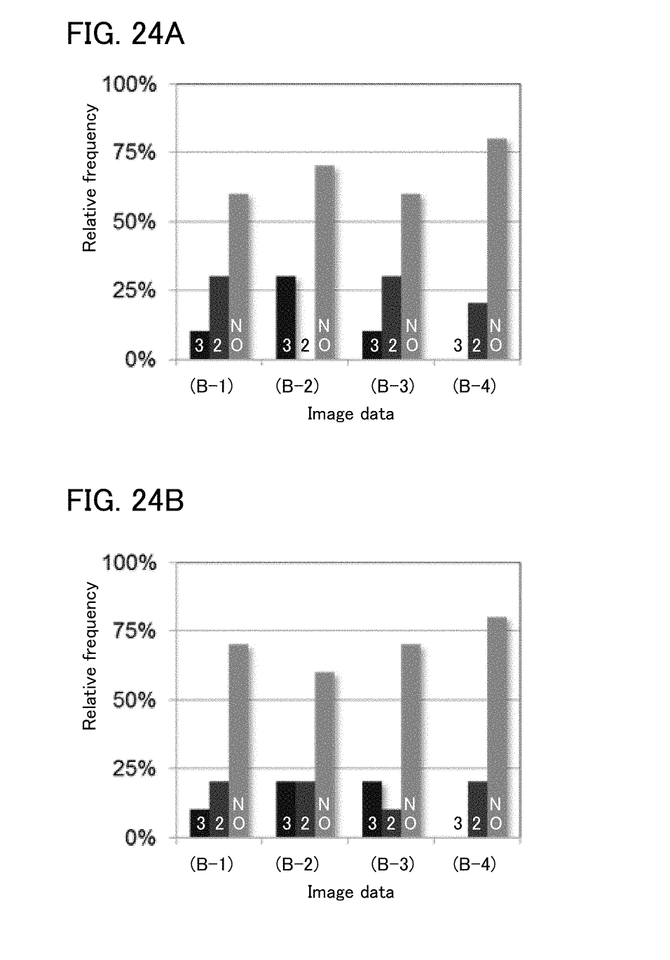

In this example, a structure and evaluation results of the display device of one embodiment of the present invention are described with reference to FIGS. 23A and 23B.

FIGS. 23A and 23B each show the results of the sensory evaluation where the illuminance of the environment is set to 150 lux.

The sensory evaluation for comparing the display using the second display method and the display using the third display method was performed in the same manner as the above, except that the illuminance of the environment was set to 150 lux using the interior light. Note that the luminance displayed by the first display element was several candelas per square metre and the luminance displayed by the second display element was 150 cd/m².

### <<Comparison Result 1>>

FIG. 23A shows the results of the sensory evaluation where the examinees were asked in which display they felt higher quality. The number of examinees who felt higher quality in the display using the third display method was substantially the same as the number of examinees who felt higher quality in the display using the second display method, and the number of examinees who had no opinion was increased except when the image B-1 was displayed.

FIG. 23B shows the results of the sensory evaluation where the examinees were asked in which display they felt higher definition. The number of examinees who felt higher definition in the display using the third display method was substantially the same as the number of examinees who felt higher definition in the display using the second display method, and the number of examinees who had no opinion was increased.

### Comparative Example 2

In this example, a structure and evaluation results of the display device of one embodiment of the present invention are described with reference to FIGS. 24A and 24B.

FIGS. 24A and 24B each show the results of the sensory evaluation where the illuminance of the environment is set to 8 lux.

The sensory evaluation for comparing the display using the second display method and the display using the third display method was performed in the same manner as the above, except that the illuminance of the environment was set to 8 lux without using lighting. Note that the luminance displayed by the first display element was less than or equal to 1 cd/m² and the luminance displayed by the second display element was 150 cd/m².

### <<Comparison Result 2>>

FIG. 24A shows the results of the sensory evaluation where the examinees were asked in which display they felt higher quality. The number of examinees who felt higher quality in the display using the third display method was substantially the same as the number of examinees who felt higher quality in the display using the second display method, and the number of examinees who had no opinion was increased.

FIG. 24B shows the results of the sensory evaluation where the examinees were asked in which display they felt higher definition. The number of examinees who felt higher definition in the display using the third display method was substantially the same as the number of examinees who felt higher definition in the display using the second display method, and the number of examinees who had no opinion was increased.

This application is based on Japanese Patent Application serial no. 2016-082104 filed with Japan Patent Office on Apr. 15, 2016, the entire contents of which are hereby incorporated by reference.

What is claimed is:

1. A display device comprising:
a display panel; and
a correction circuit,
wherein the display panel comprises a pixel,
wherein the pixel comprises a first display element and a second display element,
wherein the second display element is provided so that display using the second display element is seen from part of a region where display using the first display element is seen,
wherein the first display element is configured to receive a first gray level signal,
wherein the second display element is configured to receive a second gray level signal,
wherein the correction circuit is configured to receive gray level data,
wherein the correction circuit is configured to determine a first gray level on the basis of the gray level data and a first characteristic curve,
wherein the correction circuit is configured to generate the first gray level signal so that the first gray level is displayed by the first display element,
wherein the correction circuit is configured to supply the first gray level signal,
wherein the correction circuit is configured to determine a second gray level on the basis of the gray level data and a second characteristic curve,
wherein the correction circuit is configured to generate the second gray level signal so that the second gray level is displayed by the second display element,
wherein the correction circuit is configured to supply the second gray level signal,
wherein the first characteristic curve has a gamma value greater than 2.2 in a normalized state, and
wherein the second characteristic curve has a gamma value smaller than the gamma value of the first characteristic curve in a normalized state.

2. The display device according to claim 1,
wherein the second display element is configured to perform display with higher color purity than the first display element, and
wherein the first characteristic curve outputs a value smaller than or equal to 0.01 in response to input of a value smaller than or equal to 0.2 in the normalized state.

3. The display device according to claim 1,
wherein the first display element is configured to control reflectance, and
wherein the second display element is configured to control emission intensity.

4. The display device according to claim 3,
wherein the first display element comprises a first electrode, a second electrode, and a layer containing a liquid crystal material,
wherein the second electrode is provided so that an electric field that controls alignment of the liquid crystal material contained in the layer containing the liquid crystal material is generated between the second electrode and the first electrode,
wherein the first display element is configured to operate in a normally white mode,
wherein the first display element comprises a voltage that increases normalized reflectance from lower than 90% to higher than or equal to 90% when a voltage applied between the first electrode and the second electrode is greater than or equal to 0 V and less than or equal to 1.5 V, and
wherein the first display element comprises a voltage that increases normalized reflectance from lower than 10% to higher than or equal to 10% when a voltage applied between the first electrode and the second electrode is greater than or equal to 0 V and less than or equal to 3.5 V.

5. The display device according to claim 4,
wherein the pixel comprises a first conductive film, a second conductive film, an insulating film, and a pixel circuit,
wherein the first conductive film is electrically connected to the first electrode,
wherein the second conductive film comprises a region overlapping with the first conductive film,
wherein the insulating film comprises a region positioned between the first conductive film and the second conductive film,
wherein the insulating film comprises an opening,
wherein the second conductive film is electrically connected to the first conductive film through the opening,
wherein the pixel circuit is electrically connected to the second conductive film,
wherein the second display element is electrically connected to the pixel circuit, and
wherein the second display element is configured to emit light toward the insulating film.

6. An input/output device comprising:
the display device according to claim 1; and
an input portion,
wherein the input portion is configured to sense an object that approaches a region overlapping with the display panel.

7. The input/output device according to claim 6,
wherein the input portion comprises the region overlapping with the display panel,
wherein the input portion comprises a control line, a sensor signal line, and a sensing element,
wherein the control line is configured to supply a control signal,
wherein the sensor signal line is configured to receive a sensor signal,
wherein the sensing element is electrically connected to the control line and the sensor signal line,
wherein the sensing element has a light-transmitting property,
wherein the sensing element comprises a first electrode and a second electrode,
wherein the first electrode is electrically connected to the control line,
wherein the second electrode is electrically connected to the sensor signal line,
wherein the second electrode is provided so that an electric field part of which is blocked by an object that approaches the region overlapping with the display panel is generated between the second electrode and the first electrode, and
wherein the sensing element is configured to supply the sensor signal which changes in accordance with the control signal and a distance between the sensing element and the object that approaches the region overlapping with the display panel.

8. A data processor comprising:
at least one of a keyboard, a hardware button, a pointing device, a touch sensor, an illuminance sensor, an imaging device, an audio input device, a viewpoint input device, and an attitude determination device; and
the display device according to claim 1.
